(19) United States
(12) Patent Application Publication
(10) Pub. No.: US 2008/0021866 A1
(43) Pub. Date: Jan. 24, 2008

(54) METHOD AND SYSTEM FOR IMPLEMENTING A FLOATING IDENTITY PROVIDER MODEL ACROSS DATA CENTERS

(76) Inventors: HEATHER M HINTON, Austin, TX (US); Glen Gooding, Aptos, CA (US); Patrick R. Wardrop, Austin, TX (US)

Correspondence Address: IBM CORP. (DHJ);c/o DAVID H. JUDSON, 15950 DALLAS PARKWAY, SUITE 225, DALLAS, TX, 75248, US

(21) Appl. No.: 11/458,845

(22) Filed: Jul. 20, 2006

(51) Int. Cl. G06F 17/30

(52) U.S. Cl. 707/2

(57) ABSTRACT

A method is presented for processing transactions in a federated computational environment. Resource requests are received at a first federated entity from a second federated entity. The first federated entity responds to federation protocol operations for the second federated entity in accordance with a trust relationship between the first and second federated entity. The services of the first federated entity are provided by a set of data processing systems within a distributed data processing system, and each data processing system in the set of data processing systems is able to act as an identity provider. A first data processing system in the set of data processing systems establishes itself to act as an identity provider for the set of data processing systems with respect to the second federated entity and then is employed to perform federated protocol operations as an identity provider for requests from the second federated entity.

### BACKGROUND OF THE INVENTION

1. Field of the Invention

The present invention relates to an improved data processing system and, in particular, to a method and apparatus for multicomputer data transferring. Still more particularly, the present invention is directed to networked computer systems.

2. Description of Related Art

To reduce the costs of user management and to improve interoperability among enterprises, federated computing spaces have been created. A federation is a loosely coupled affiliation of enterprises which adhere to certain standards of interoperability; the federation provides a mechanism for trust among those enterprises with respect to certain computational operations for the users within the federation. For example, a federation partner may act as a user's home domain or identity provider. Other partners within the same federation may rely on the user's identity provider for primary management of the user's authentication credentials, e.g., accepting a single-sign-on token that is provided by the user's identity provider.

As enterprises move to support federated business interactions, these enterprises should provide a user experience that reflects the increased cooperation between two businesses and minimizes the operational burdens of a user. Within these federations, these enterprises have begun to interoperate to support a variety of federation protocols of which a user may be unaware or may be only minimally aware. For example, federated enterprises may perform various types of operations for user account management, such as managing a user-specific alias identifier, that might require minimal interaction with the user to complete an operation. The federated enterprises should cooperate to an extent that the user is not confused or overburdened with knowledge of the underlying mechanism by which such types of operations are coordinated.

However, there is a tradeoff that should be considered in the implementation of these operations within a federation. Various operations, such as those that might require minimal interaction with the user to complete an operation, should also be performed in a manner that is efficient for the federated enterprises, particularly for those types of operations that might be required across all users within an enterprise. For example, when a particular operation needs to be performed for thousands or millions of users, such as all customers of a particular enterprise, the mechanism for performing the operation needs to be scalable such that it does not overburden the computational resources of the federated enterprise, yet these various types of operations may be implemented in a variety of ways that vary in their burdens upon the federated enterprises that are involved with the necessary operation.

One manner of addressing the burden on computational resources within a federated enterprise is to implement the federated functionality within a distributed data processing system. For example, the services of an identity provider could be supported within a distributed data processing system. However, the characteristics of a distributed data processing system may be problematic; some of the requirements of federated protocol operations would complicate the implementation of the functionality for performing those federated protocol operations within a distributed data processing system.

Therefore, it would be advantageous to implement a federated enterprise and its computational infrastructure such that federated protocol operations within the data processing systems of the federated enterprises can be efficiently and configurably managed. It would be particularly advantageous to efficiently implement functionality for federated protocol operations within a distributed data processing system, particularly the functionality for performing federated protocol operations of an identity provider within a distributed data processing system.

### SUMMARY OF THE INVENTION

A method, an apparatus, and a computer program product are presented for processing transactions in a federated computational environment. Resource requests are received at a first federated entity from a second federated entity. The first federated entity responds to federation protocol operations for the second federated entity in accordance with a trust relationship between the first federated entity and the second federated entity. The services of the first federated entity are provided by a set of data processing systems within a distributed data processing system, and each data processing system in the set of data processing systems is able to act as an identity provider. A first data processing system in the set of data processing systems establishes itself to act as an identity provider for the set of data processing systems with respect to the second federated entity. The first data center is then employed to perform federated protocol operations as an identity provider for requests from the second federated entity.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 2 depicts a block diagram that illustrates the terminology of the federated environment with respect to a transaction that is initiated by a user to a first federated enterprise, which, in response, invokes actions at downstream entities within the federated environment;

FIG. 3 depicts a block diagram that illustrates the integration of pre-existing data processing systems at a given domain with some federated architecture components that may be used to support an embodiment of the present invention;

FIG. 4 depicts a block diagram that illustrates an example of a manner in which some components within a federated architecture may be used to establish trust relationships to support an implementation of the present invention;

FIG. 5 depicts a block diagram that illustrates an exemplary set of trust relationships between federated domains using trust proxies and a trust broker in accordance with an exemplary federated architecture that is able to support the present invention;

FIG. 6 depicts a block diagram that illustrates a federated environment that supports federated single-sign-on operations;

FIG. 7 depicts a block diagram that illustrates some of the components in a federated domain for implementing federated user lifecycle management functionality in order to support the present invention;

FIG. 8A depicts a block diagram that illustrates a federated entity that is implemented as a distributed data processing system to support flexible assignment of resources for implementing identity provider functionality;

FIGS. 8B-8E depict block diagrams that illustrate a scenario in which a first federated entity interacts with a second federated entity that is implemented using a distributed data processing system to support a floating identity provider;

FIGS. 9A-9C depict a set of flowcharts that illustrate a process for handling a resource request within a federated entity that supports the assignment of a floating identity provider;

FIGS. 10A-10D depict a set of text strings that illustrate some of the information that may be embedded within a cookie to support the assignment of a floating identity provider;

FIGS. 11A-11B depict a pair of flowcharts that illustrate processes for resetting an assignment of a floating identity provider; and

FIG. 12 depicts a data flow diagram that illustrates some of the data traffic that may be transmitted between a federated client or user and a federated entity that supports a floating identity provider.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

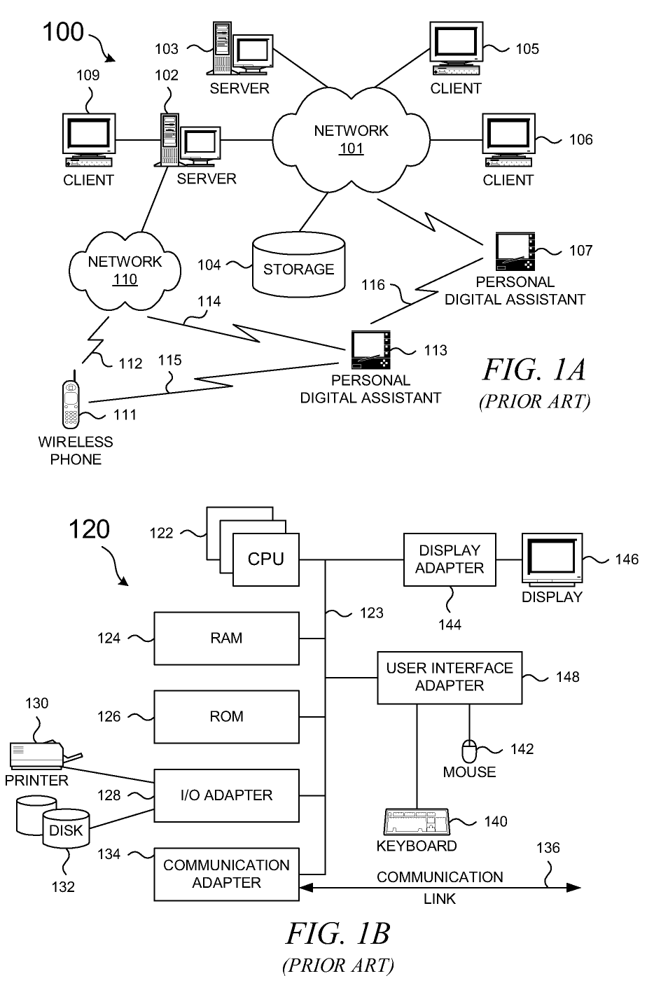

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

Given the preceding brief description of some current technology, the description of the remaining figures relates to federated computer environments in which the present invention may operate. Prior to discussing the present invention in more detail, however, some terminology is introduced.

Terminology

The terms “entity” or “party” generally refers to an organization, an individual, or a system that operates on behalf of an organization, an individual, or another system. The term “domain” connotes additional characteristics within a network environment, but the terms “entity”, “party”, and “domain” can be used interchangeably. For example, the term “domain” may also refer to a DNS (Domain Name System) domain, or more generally, to a data processing system that includes various devices and applications that appear as a logical unit to exterior entities.

The terms “request” and “response” should be understood to comprise data formatting that is appropriate for the transfer of information that is involved in a particular operation, such as messages, communication protocol information, or other associated information. A protected resource is a resource (an application, an object, a document, a page, a file, executable code, or other computational resource, communication-type resource, etc.) for which access is controlled or restricted.

A token provides direct evidence of a successful operation and is produced by the entity that performs the operation, e.g., an authentication token that is generated after a successful authentication operation. A Kerberos token is one example of an authentication token that may be used with the present invention. More information on Kerberos may be found in Kohl et al., “The Kerberos Network Authentication Service (V5)”, Internet Engineering Task Force (IETF) Request for Comments (RFC) 1510, 09/1993.

An assertion provides indirect evidence of some action. Assertions may provide indirect evidence of identity, authentication, attributes, authorization decisions, or other information and/or operations. An authentication assertion provides indirect evidence of authentication by an entity that is not the authentication service but that listened to the authentication service.

A Security Assertion Markup Language (SAML) assertion is an example of a possible assertion format that may be used with the present invention. SAML has been promulgated by the Organization for the Advancement of Structured Information Standards (OASIS), which is a non-profit, global consortium. SAML is described in “Assertions and Protocol for the OASIS Security Assertion Markup Language (SAML)”, Committee Specification 01, May 31, 2002, as follows:
The Security Assertion Markup Language (SAML) is an XML-based framework for exchanging security information. This security information is expressed in the form of assertions about subjects, where a subject is an entity (either human or computer) that has an identity in some security domain. A typical example of a subject is a person, identified by his or her email address in a particular Internet DNS domain. Assertions can convey information about authentication acts performed by subjects, attributes of subjects, and authorization decisions about whether subjects are allowed to access certain resources. Assertions are represented as XML constructs and have a nested structure, whereby a single assertion might contain several different internal statements about authentication, authorization, and attributes. Note that assertions containing authentication statements merely describe acts of authentication that happened previously. Assertions are issued by SAML authorities, namely, authentication authorities, attribute authorities, and policy decision points. SAML defines a protocol by which clients can request assertions from SAML authorities and get a response from them. This protocol, consisting of XML-based request and response message formats, can be bound to many different underlying communications and transport protocols; SAML currently defines one binding, to SOAP over HTTP. SAML authorities can use various sources of information, such as external policy stores and assertions that were received as input in requests, in creating their responses. Thus, while clients always consume assertions, SAML authorities can be both producers and consumers of assertions.
   The SAML specification states that an assertion is a package of information that supplies one or more statements made by an issuer. SAML allows issuers to make three different kinds of assertion statements: authentication, in which the specified subject was authenticated by a particular means at a particular time; authorization, in which a request to allow the specified subject to access the specified resource has been granted or denied; and attribute, in which the specified subject is associated with the supplied attributes. As discussed further below, various assertion formats can be translated to other assertion formats when necessary.

Authentication is the process of validating a set of credentials that are provided by a user or on behalf of a user. Authentication is accomplished by verifying something that a user knows, something that a user has, or something that the user is, i.e. some physical characteristic about the user. Something that a user knows may include a shared secret, such as a user's password, or by verifying something that is known only to a particular user, such as a user's cryptographic key. Something that a user has may include a smartcard or hardware token. Some physical characteristic about the user might include a biometric input, such as a fingerprint or a retinal map. It should be noted that a user is typically but not necessarily a natural person; a user could be a machine, computing device, or other type of data processing system that uses a computational resource. It should also be noted that a user typically but not necessarily possesses a single unique identifier; in some scenarios, multiple unique identifiers may be associated with a single user.

An authentication credential is a set of challenge/response information that is used in various authentication protocols. For example, a username and password combination is the most familiar form of authentication credentials. Other forms of authentication credential may include various forms of challenge/response information, Public Key Infrastructure (PKI) certificates, smartcards, biometrics, etc. An authentication credential is differentiated from an authentication assertion: an authentication credential is presented by a user as part of an authentication protocol sequence with an authentication server or service, and an authentication assertion is a statement about the successful presentation and validation of a user's authentication credentials, subsequently transferred between entities when necessary.

Federation Model for Computing Environment that May Incorporate the Present Invention

In the context of the World Wide Web, users are coming to expect the ability to jump from interacting with an application on one Internet domain to another application on another domain with minimal regard to the information barriers between each particular domain. Users do not want the frustration that is caused by having to authenticate to multiple domains for a single transaction. In other words, users expect that organizations should interoperate, but users generally want domains to respect their privacy. In addition, users may prefer to limit the domains that permanently store private information. These user expectations exist in a rapidly evolving heterogeneous environment in which many enterprises and organizations are promulgating competing authentication techniques.

The present invention is supported within a federation model that allows enterprises to provide a single-sign-on experience to a user. In other words, the present invention may be implemented within a federated, heterogeneous environment. As an example of a transaction that would benefit from a federated, heterogeneous environment, a user is able to authenticate to a domain and then have the domain provide the appropriate assertions to each downstream domain that might be involved in a transaction. These downstream domains need to be able to understand and trust authentication assertions and/or other types of assertions, even though there are no pre-established assertion formats between the domain and these other downstream domains. In addition to recognizing the assertions, the downstream domains need to be able to translate the identity contained within an assertion to an identity that represents the user within a particular domain, even though there is no pre-established identity mapping relationship.

The present invention is supported within a federated environment. In general, an enterprise has its own user registry and maintains relationships with its own set of users. Each enterprise typically has its own means of authenticating these users. However, the federated scheme for use with the present invention allows enterprises to cooperate in a collective manner such that users in one enterprise can leverage relationships with a set of enterprises through an enterprise's participation in a federation of enterprises. Users can be granted access to resources at any of the federated enterprises as if they had a direct relationship with each enterprise. Users are not required to register at each business of interest, and users are not constantly required to identify and authenticate themselves. Hence, within this federated environment, an authentication scheme allows for a single-sign-on experience within the rapidly evolving heterogeneous environments in information technology.

In the context of the present invention, a federation is a set of distinct entities, such as enterprises, logical units within an enterprise, organizations, institutions, etc., that cooperate to provide a single-sign-on, ease-of-use experience to a user; a federated environment differs from a typical single-sign-on environment in that two enterprises need not have a direct, pre-established, relationship defining how and what information to transfer about a user. Within a federated environment, entities provide services which deal with authenticating users, accepting authentication assertions, e.g., authentication tokens, that are presented by other entities, and providing some form of translation of the identity of the vouched-for user into one that is understood within the local entity.

Federation eases the administrative burden on service providers. A service provider can rely on its trust relationships with respect to the federation as a whole; the service provider does not need to manage authentication information, such as user password information, because it can rely on authentication that is accomplished by a user's authentication home domain or an identity provider.

The system that supports the present invention also concerns a federated identity management system that establishes a foundation in which loosely coupled authentication, user enrollment, user profile management and/or authorization services collaborate across security domains. Federated identity management allows services residing in disparate security domains to securely interoperate and collaborate even though there may be differences in the underlying security mechanisms and operating system platforms at these disparate domains.

Identity Provider vs. Service Provider

As mentioned above and as explained in more detail further below, a federated environment provides significant user benefits. A federated environment allows a user to authenticate at a first entity, which may act as an issuing party to issue an authentication assertion about the user for use at a second entity. The user can then access protected resources at a second, distinct entity, termed the relying party, by presenting the authentication assertion that was issued by the first entity without having to explicitly re-authenticate at the second entity. Information that is passed from an issuing party to a relying party is in the form of an assertion, and this assertion may contain different types of information in the form of statements. For example, an assertion may be a statement about the authenticated identity of a user, or it may be a statement about user attribute information that is associated with a particular user. Furthermore, this information can be used by a relying party to provide access to the relying party's resources, based on the relying party's access control rules, identity mapping rules, and possibly some user attributes that are maintained by the relying party.

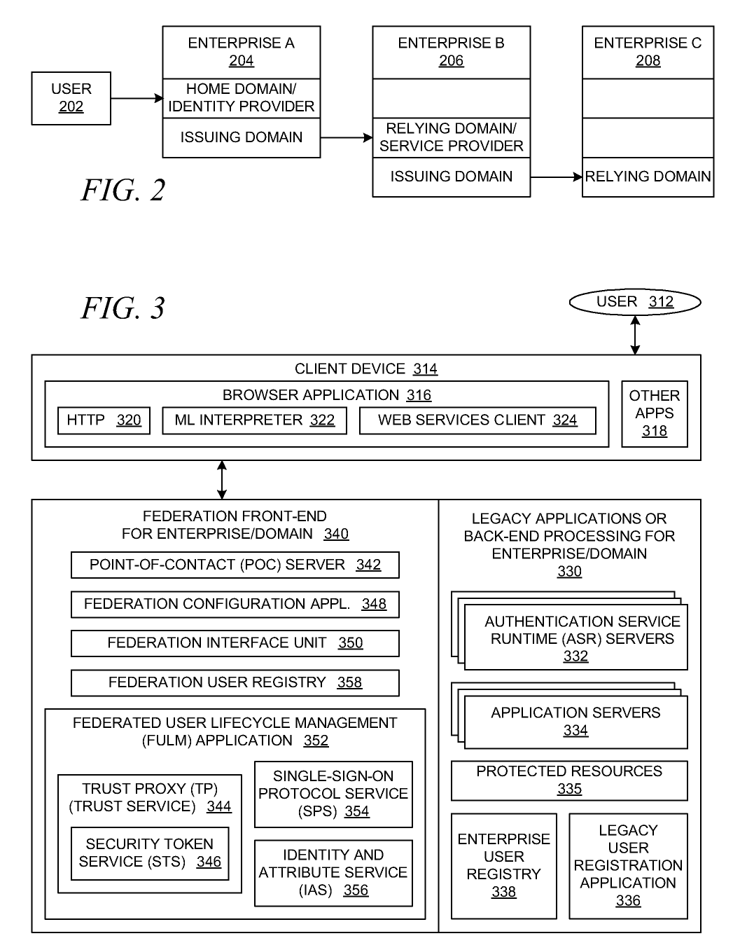

With reference now to FIG. 2, a block diagram depicts the terminology of the federated environment with respect to a transaction that is initiated by a user to a first federated enterprise, which, in response, invokes actions at downstream entities within the federated environment. FIG. 2 shows that the terminology may differ depending on the perspective of an entity within the federation for a given federated operation. More specifically, FIG. 2 illustrates that a computing environment that supports the present invention supports the transitivity of trust and the transitivity of the authentication assertion process; a domain or an entity can issue an assertion based on its trust in an identity as asserted by another domain or another entity.

User 202 initiates a transaction through a request for a protected resource at enterprise 204. If user 202 has been authenticated by enterprise 204 or will eventually be authenticated by enterprise 204 during the course of a transaction, then enterprise 204 may be termed the user's home domain for this federated session. Assuming that the transaction requires some type of operation by enterprise 206 and enterprise 204 transfers an assertion to enterprise 206, then enterprise 204 is the issuing entity with respect to the particular operation, and enterprise 206 is the relying entity for the operation.

The issuing entity issues an assertion for use by the relying domain; an issuing entity is usually, but not necessarily, the user's home domain or the user's identity provider. Hence, it would usually be the case that the issuing party has authenticated the user using a typical authentication operation. However, it is possible that the issuing party has previously acted as a relying party whereby it received an assertion from a different issuing party. In other words, since a user-initiated transaction may cascade through a series of enterprises within a federated environment, a receiving party may subsequently act as an issuing party for a downstream transaction. In general, any entity that has the ability to issue authentication assertions on behalf of a user can act as an issuing entity.

The relying entity is an entity that receives an assertion from an issuing entity. The relying party is able to accept, trust, and understand an assertion that is issued by a third party on behalf of the user, i.e. the issuing entity; it is generally the relying entity's duty to use an appropriate authentication authority to interpret an authentication assertion. A relying party is an entity that relies on an assertion that is presented on behalf of a user or another entity. In this manner, a user can be given a single-sign-on experience at the relying entity instead of requiring the relying entity to prompt the user for the user's authentication credentials as part of an interactive session with the user.

Referring again to FIG. 2, assuming that the transaction requires further operations such that enterprise 206 transfers an assertion to enterprise 208, then enterprise 206 is an upstream entity that acts as the issuing entity with respect to the subsequent or secondary transaction operation, and enterprise 208 is a downstream entity that acts as the relying entity for the operation; in this case, enterprise 208 may be regarded as another downstream entity with respect to the original transaction, although the subsequent transaction can also be described with respect to only two entities.

As shown in FIG. 2, a federated entity may act as a user's home domain, which provides identity information and attribute information about federated users. An entity within a federated computing environment that provides identity information, identity or authentication assertions, or identity services may be termed an identity provider. Other entities or federation partners within the same federation may rely on an identity provider for primary management of a user's authentication credentials, e.g., accepting a single-sign-on token that is provided by the user's identity provider; a domain at which the user authenticates may be termed the user's (authentication) home domain. The identity provider may be physically supported by the user's employer, the user's ISP, or some other commercial entity.

An identity provider is a specific type of service that provides identity information as a service to other entities within a federated computing environment. With respect to most federated transactions, an issuing party for an authentication assertion would usually be an identity provider; any other entity can be distinguished from the identity provider. Any other entity that provides a service within the federated computing environment can be categorized as a service provider. Once a user has authenticated to the identity provider, other entities or enterprises in the federation may be regarded as merely service providers for the duration of a given federated session or a given federated transaction.

In some circumstances, there may be multiple entities within a federated environment that may act as identity providers for a user. For example, the user may have accounts at multiple federated domains, each of which is able to act as an identity provider for the user; these domains do not necessarily have information about the other domains nor about a user's identity at a different domain.

Although it may be possible that there could be multiple enterprises within a federated environment that may act as identity providers, e.g., because there may be multiple enterprises that have the ability to generate and validate a user's authentication credentials, etc., a federated transaction usually involves only a single identity provider. If there is only a single federated entity that is able to authenticate a user, e.g., because there is one and only one entity within the federation with which the user has performed a federated enrollment or registration operation, then it would be expected that this entity would act as the user's identity provider in order to support the user's transactions throughout the federated environment.

Within some federated transactions that require the interoperation of multiple service providers, a downstream service provider may accept an assertion from an upstream service provider; the conditions in which an upstream service provider may act as an issuing entity to a downstream service provider that is acting as a relying party may depend upon the type of trust relationship between the service providers and the type of transaction between the service providers. Within the scope of a simple federated transaction, however, there is only one entity that acts as an issuing entity.

The present invention may be supported within a given computing environment in which a federated infrastructure can be added to existing systems while minimizing the impact on an existing, non-federated architecture. Hence, operations, including authentication operations, at any given enterprise or service provider are not necessarily altered by the fact that an entity may also participate within a federated environment. In other words, even though an entity's computing systems may be integrated into a federated environment, a user may be able to continue to perform various operations, including authentication operations, directly with an enterprise in a non-federated manner. However, the user may be able to have the same end-user experience while performing a federated operation with respect to a given entity as if the user had performed a similar operation with the given entity in a non-federated manner. Hence, it should be noted that not all of a given enterprise's users necessarily participate federated transactions when the given enterprise participates in a federation; some of the enterprise's users may interact with the enterprise's computing systems without performing any federated transactions.

Moreover, user registration within the computing environment of a given enterprise, e.g., establishment of a user account in a computer system, is not necessarily altered by the fact that the enterprise may also participate within a federated environment. For example, a user may still establish an account at a domain through a legacy or pre-existing registration process that is independent of a federated environment. Hence, in some cases, the establishment of a user account at an enterprise may or may not include the establishment of account information that is valid across a federation when the enterprise participates within a federated computing environment.

Federated Architecture—Federation Front-End for Legacy Systems

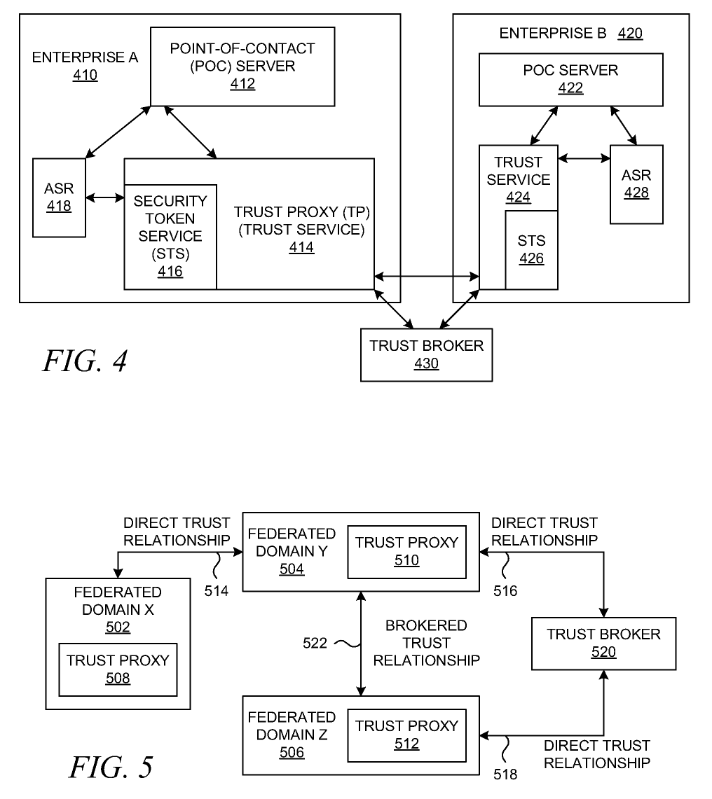

With reference now to FIG. 3, a block diagram depicts the integration of pre-existing data processing systems at a given domain with some federated architecture components that may be used to support an embodiment of the present invention. A federated environment includes federated entities that provide a variety of services for users. User 312 interacts with client device 314, which may support browser application 316 and various other client applications 318. User 312 is distinct from client device 314, browser 316, or any other software that acts as interface between user and other devices and services. In some cases, the following description may make a distinction between the user acting explicitly within a client application and a client application that is acting on behalf of the user. In general, though, a requester is an intermediary, such as a client-based application, browser, SOAP client, etc., that may be assumed to act on behalf of the user.

Browser application 316 may be a typical browser, including those found on mobile devices, that comprises many modules, such as HTTP communication component 320 and markup language (ML) interpreter 322. Browser application 316 may also support plug-ins, such as web services client 324, and/or downloadable applets, which may or may not require a virtual machine runtime environment. Web services client 324 may use Simple Object Access Protocol (SOAP), which is a lightweight protocol for defining the exchange of structured and typed information in a decentralized, distributed environment. SOAP is an XML-based protocol that consists of three parts: an envelope that defines a framework for describing what is in a message and how to process it; a set of encoding rules for expressing instances of application-defined datatypes; and a convention for representing remote procedure calls and responses. User 312 may access web-based services using browser application 316, but user 312 may also access web services through other web service clients on client device 314. Some of the federated operations may employ HTTP redirection via the user's browser to exchange information between entities in a federated environment. However, it should be noted that the present invention may be supported over a variety of communication protocols and is not meant to be limited to HTTP-based communications. For example, the entities in the federated environment may communicate directly when necessary; messages are not required to be redirected through the user's browser.

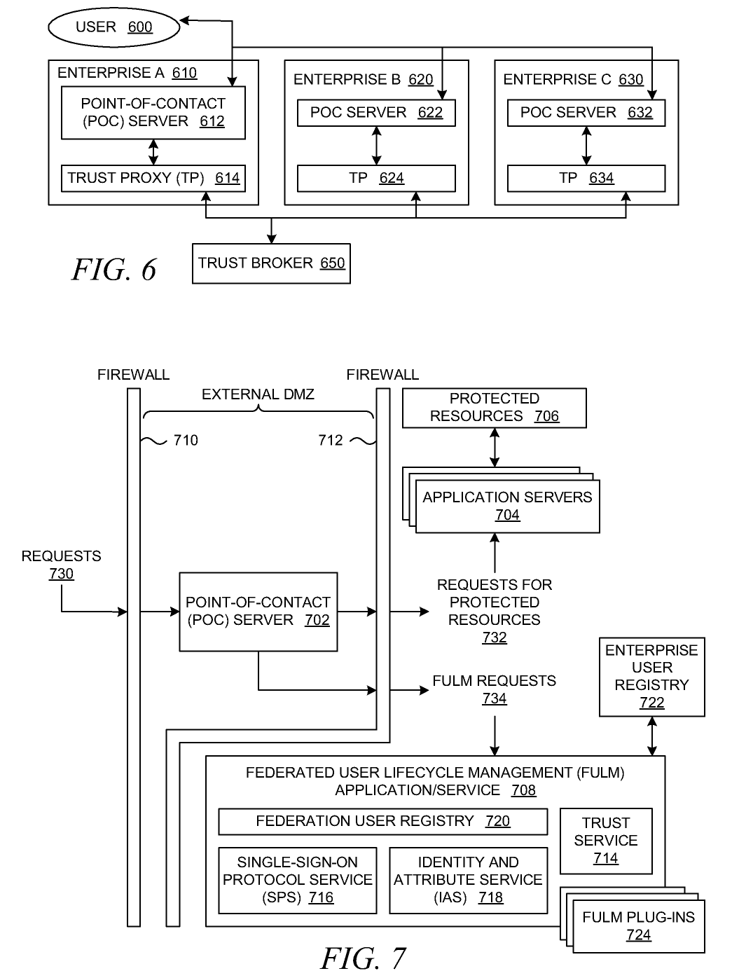

The present invention may be supported in a manner such that components that are required for a federated environment can be integrated with pre-existing systems. FIG. 3 depicts one embodiment for implementing these components as a front-end to a pre-existing system. The pre-existing components at a federated domain can be considered as legacy applications or back-end processing components 330, which include authentication service runtime (ASR) servers 332 in a manner similar to that shown in FIG. 4. ASR servers 332 are responsible for authenticating users when the domain controls access to application servers 334, which can be considered to generate, retrieve, or otherwise support or process protected resources 335. The domain may continue to use legacy user registration application 336 to register users for access to application servers 334. Information that is needed to authenticate a registered user with respect to legacy operations is stored in enterprise user registry 338; enterprise user registry 338 may be accessible to federation components as well.

After joining a federated environment, the domain may continue to operate without the intervention of federated components. In other words, the domain may be configured so that users may continue to access particular application servers or other protected resources directly without going through a point-of-contact server or other component implementing this point-of-contact server functionality; a user that accesses a system in this manner would experience typical authentication flows and typical access. In doing so, however, a user that directly accesses the legacy system would not be able to establish a federated session that is known to the domain's point-of-contact server.

The domain's legacy functionality can be integrated into a federated environment through the use of federation front-end processing 340, which includes point-of-contact server 342 and trust proxy server 344 (or more simply, trust proxy 344 or trust service 344) which itself interacts with Security Token Service (STS) 346, which are described in more detail below with respect to FIG. 4. Federation configuration application 348 allows an administrative user to configure the federation front-end components to allow them to interface with the legacy back-end components through federation interface unit 350. Federated functionality may be implemented in distinct system components or modules. In a preferred embodiment, most of the functionality for performing federation operations may be implemented by a collection of logical components within a single federation application; federated user lifecycle management application 352 includes trust service 344 along with single-sign-on protocol service (SPS) 354. Trust service 344 may comprise identity-and-attribute service (IAS) 356, which is responsible for identity mapping operations, attribute retrieval, etc., as part of federation functionality. Identity-and-attribute service 356 may also be employed by single-sign-on protocol service 354 during single-sign-on operations. A federation user registry 358 may be employed in certain circumstances to maintain user-related information for federation-specific purposes.

Legacy or pre-existing authentication services at a given enterprise may use various, well known, authentication methods or tokens, such as username/password or smart card token-based information. However, in a preferred federated computing system for supporting the present invention, the functionality of a legacy authentication service can be used in a federated environment through the use of point-of-contact servers. Users may continue to access a legacy authentication server directly without going through a point-of-contact server, although a user that accesses a system in this manner would experience typical authentication flows and typical access; a user that directly accesses a legacy authentication system would not be able to generate a federated authentication assertion as proof of identity in accordance with the present invention. One of the roles of the federation front-end is to translate a federated authentication token received at a point-of-contact server into a format understood by a legacy authentication service. Hence, a user accessing the federated environment via the point-of-contact server would not necessarily be required to re-authenticate to the legacy authentication service. Preferably, the user would be authenticated to a legacy authentication service by a combination of the point-of-contact server and a trust proxy such that it appears as if the user was engaged in an authentication dialog.

Federated Architecture—Point-of-Contact Servers, Trust Proxies, and Trust Brokers

With reference now to FIG. 4, a block diagram depicts an example of a manner in which some components within a federated architecture may be used to establish trust relationships to support an implementation of the present invention. A federated environment includes federated enterprises or similar entities that provide a variety of services for users. A user, through an application on a client device, may attempt to access resources at various entities, such as enterprise 410. A point-of-contact server at each federated enterprise, such as point-of-contact (POC) server 412 at enterprise 410, is the entry point into the federated environment for requests from a client to access resources that are supported and made available by enterprise 410. The point-of-contact server minimizes the impact on existing components within an existing, non-federated architecture, e.g., legacy systems, because the point-of-contact server handles many of the federation requirements. The point-of-contact server provides session management, protocol conversion, and possibly initiates authentication and/or attribute assertion conversion. For example, the point-of-contact server may translate HTTP or HTTPS messages to SOAP and vice versa. As explained in more detail further below, the point-of-contact server may also be used to invoke a trust proxy to translate assertions, e.g., a SAML token received from an issuing party can be translated into a Kerberos token understood by a receiving party.

A trust service (also termed a trust proxy, a trust proxy server, or a trust service), such as trust proxy (TP) 414 at enterprise 410, establishes and maintains a trust relationship between two entities in a federation. A trust service generally has the ability to handle authentication token format translation (through the security token service, which is described in more detail further below) from a format used by the issuing party to one understood by the receiving party.

Together, the use of a point-of-contact server and a trust service minimize the impact of implementing a federated architecture on an existing, non-federated set of systems. Hence, the exemplary federated architecture requires the implementation of at least one point-of-contact server and at least one trust service per federated entity, whether the entity is an enterprise, a domain, or other logical or physical entity. The exemplary federated architecture, though, does not necessarily require any changes to the existing, non-federated set of systems. Preferably, there is a single trust service for a given federated entity, although there may be multiple instances of a trust service component for availability purposes, or there may be multiple trust services for a variety of smaller entities within a federated entity, e.g., separate subsidiaries within an enterprise. It is possible that a given entity could belong to more than one federation, although this scenario would not necessarily require multiple trust services as a single trust service may be able to manage trust relationships within multiple federations.

One role of a trust service may be to determine or to be responsible for determining the required token type by another domain and/or the trust service in that domain. A trust service has the ability or the responsibility to handle authentication token format translation from a format used by the issuing party to one understood by the receiving party. Trust service 414 may also be responsible for any user identity translation or attribute translation that occurs for enterprise 410, or this responsibility may be supported by a distinct identity-and-attribute service, e.g., such as identity-and-attribute service 356 as shown in FIG. 3. In addition, a trust service can support the implementation of aliases as representatives of a user identity that uniquely identify a user without providing any addition information about the user's real world identity. Furthermore, a trust proxy can issue authorization and/or session credentials for use by the point-of-contact server. However, a trust service may invoke a trust broker for assistance, as described further below. Identity translation may be required to map a user's identity and attributes as known to an issuing party to one that is meaningful to a receiving party. This translation may be invoked by either a trust service at an issuing entity, a trust service at a receiving entity, or both.

Trust service 414, or a distinct identity-and-attribute service as mentioned above, may include (or interact with) an internalized component, shown as security token service (STS) component 416, which will provide token translation and will invoke authentication service runtime (ASR) 418 to validate and generate tokens. The security token service provides the token issuance and validation services required by the trust service, which may include identity translation. The security token service therefore includes an interface to existing authentication service runtimes, or it incorporates authentication service runtimes into the service itself. Rather than being internalized within the trust service, the security token service component may also be implemented as a stand-alone component, e.g., to be invoked by the trust service, or it may be internalized within a transaction server, e.g., as part of an application server.

For example, an security token service component may receive a request to issue a Kerberos token. As part of the authentication information of the user for whom the token is to be created, the request may contain a binary token containing a username and password. The security token service component will validate the username and password against, e.g., an LDAP runtime (typical authentication) and will invoke a Kerberos KDC (Key Distribution Center) to generate a Kerberos ticket for this user. This token is returned to the trust service for use within the enterprise; however, this use may include externalizing the token for transfer to another domain in the federation.

A user may desire to access resources at multiple enterprises within a federated environment, such as both enterprise 410 and enterprise 420. In a manner similar to that described above for enterprise 410, enterprise 420 comprises point-of-contact server 422, trust service 424, security token service (STS) 426, and authentication service runtime 428. Although the user may directly initiate separate transactions with each enterprise, the user may initiate a transaction with enterprise 410 which cascades throughout the federated environment. Enterprise 410 may require collaboration with multiple other enterprises within the federated environment, such as enterprise 420, to complete a particular transaction, even though the user may not have been aware of this necessity when the user initiated a transaction. Enterprise 420 becomes involved as a downstream entity, and enterprise 410 may present a assertion to enterprise 420 if necessary in order to further the user's federated transaction.

It may be the case that a trust service does not know how to interpret the authentication token that is received by an associated point-of-contact server and/or how to translate a given user identity and attributes. In this case, the trust service may choose to invoke functionality at a trust broker component, such as trust broker 430. A trust broker maintains relationships with individual trust proxies/services, thereby providing transitive trust between trust services. Using a trust broker allows each entity within a federated environment, such enterprises 410 and 420, to establish a trust relationship with the trust broker rather than establishing multiple individual trust relationships with each entity in the federated environment. For example, when enterprise 420 becomes involved as a downstream entity for a transaction initiated by a user at enterprise 410, trust service 414 at enterprise 410 can be assured that trust service 424 at enterprise 420 can understand an assertion from trust service 414 by invoking assistance at trust broker 430 if necessary. Although FIG. 4 depicts the federated environment with a single trust broker, a federated environment may have multiple trust brokers.

It should be noted that although FIG. 4 depicts point-of-contact server 412, trust service 414, security token service component 416, and authentication service runtime 418 as distinct entities, it is not necessary for these components to be implemented on separate components. For example, it is possible for the functionality of these separate components to be implemented as a single application, as applications on a single physical device, or as distributed applications on multiple physical devices. In addition, FIG. 4 depicts a single point-of-contact server, a single trust service, and a single security token server for an enterprise, but an alternative configuration may include multiple point-of-contact servers, multiple trust services, and multiple security token servers for each enterprise. The point-of-contact server, the trust service, the security token service, and other federated entities may be implemented in various forms, such as software applications, objects, modules, software libraries, etc.

A trust service/STS may be capable of accepting and validating many different authentication credentials, including traditional credentials such as a username and password combinations and Kerberos tickets, and federated authentication token formats, including authentication tokens produced by a third party. A trust service/STS may allow the acceptance of an authentication token as proof of authentication elsewhere. The authentication token is produced by an issuing party and is used to indicate that a user has already authenticated to that issuing party. The issuing party produces the authentication token as a means of asserting the authenticated identity of a user. A trust service/STS is also able to process attribute tokens or tokens that are used to secure communication sessions or conversations, e.g., those that are used to manage session information in a manner similar to an SSL session identifier.

A security token service invokes an authentication service runtime as necessary. The authentication service runtime supports an authentication service capable of authenticating a user. The authentication service acts as an authentication authority that provides indications of successful or failed authentication attempts via authentication responses. The trust service/STS may internalize an authentication service, e.g., a scenario in which there is a brand-new installation of a web service that does not need to interact with an existing legacy infrastructure. Otherwise, the security token service component will invoke external authentication services for validation of authentication tokens. For example, the security token service component could “unpack” a token containing a username/password and then use an LDAP service to access a user registry to validate the presented credentials.

When used by another component such as an application server, the security token service component can be used to produce tokens required for single-sign-on to legacy authentication systems; this functionality may be combined with or replaced by functionality within a single-sign-on protocol service, such as SPS 354 that is shown in FIG. 3. Hence, the security token service component can be used for token translation for internal purposes, i.e. within an enterprise, and for external purposes, i.e. across enterprises in a federation. As an example of an internal purpose, a Web application server may interface to a mainframe via an IBM CICS (Customer Information Control System) transaction gateway; CICS is a family of application servers and connectors that provides enterprise-level online transaction management and connectivity for mission-critical applications. The Web application server may invoke the security token service component to translate a Kerberos ticket (as used internally by the Web application server) to an IBM RACF® passticket required by the CICS transaction gateway.

The entities that are shown in FIG. 4 can be explained using the terminology that was introduced above, e.g., “identity provider” and “service provider”. As part of establishing and maintaining trust relationships, an identity provider's trust service can determine what token types are required/accepted by a service provider's trust service. Thus, trust services use this information when invoking token services from a security token service. When an identity provider's trust service is required to produce an authentication assertion for a service provider, the trust service determines the required token type and requests the appropriate token from the security token service.

When a service provider's trust service receives an authentication assertion from an identity provider, the trust service knows what type of assertion that it expected and what type of assertion that it needs for internal use within the service provider. The service provider's trust service therefore requests that the security token service generate the required internal-use token based on the token in the received authentication assertion.

Both trust services and trust brokers have the ability to translate an assertion received from an identity provider into a format that is understood by a service provider. The trust broker has the ability to interpret the assertion format (or formats) for each of the trust services with whom there is a direct trust relationship, thereby allowing the trust broker to provide assertion translation between an identity provider and a service provider. This translation can be requested by either party through its local trust service. Thus, the identity provider's trust service can request translation of an assertion before it is sent to the service provider. Likewise, the service provider's trust service can request translation of an assertion received from an identity provider.

Assertion translation comprises user identity translation, authentication assertion translation, attribute assertion translation, or other forms of assertion translation. Reiterating the point above, assertion translation is handled by the trust components within a federation, e.g., trust services and trust brokers. A trust service may perform the translation locally, either at the identity provider or at the service provider, or a trust service may invoke assistance from a trust broker.

Assuming that an identity provider and a service provider already have individual trust relationships with a trust broker, the trust broker can dynamically create, i.e. broker, new trust relationships between issuing parties and relying parties if necessary. After the initial trust relationship brokering operation that is provided by the trust broker, the identity provider and the service provider may directly maintain the relationship so that the trust broker need not be invoked for future translation requirements. It should be noted that translation of authentication tokens can happen at three possible places: the identity provider's trust service, the service provider's trust service, and the trust broker. Preferably, the identity provider's trust service generates an authentication assertion that is understood by the trust broker to send to the service provider. The service provider then requests a translation of this token from the trust broker into a format recognizable by the service provider. Token translation may occur before transmission, after transmission, or both before and after transmission of the authentication assertion.

Trust Relationships within Federated Architecture

Within an exemplary federated environment that is able to support the present invention, there are two types of “trust domains” that must be managed: enterprise trust domains and federation trust domains. The differences between these two types of trust domain are based in part on the business agreements governing the trust relationships with the trust domain and the technology used to establish trust. An enterprise trust domain contains those components that are managed by the enterprise; all components within that trust domain may implicitly trust each other. In general, there are no business agreements required to establish trust within an enterprise because the deployed technology creates inherent trust within an enterprise, e.g., by requiring mutually authenticated SSL sessions between components or by placing components within a single, tightly controlled data center such that physical control and proximity demonstrate implicit trust. Referring to FIG. 2B, the legacy applications and back-end processing systems may represent an enterprise trust domain, wherein the components communicate on a secure internal network.

Federation trust domains are those that cross enterprise boundaries; from one perspective, a federation trust domain may represent trust relationships between distinct enterprise trust domains. Federation trust domains are established through trust proxies across enterprise boundaries between federation partners. Trust relationships involve some sort of a bootstrapping process by which initial trust is established between trust proxies. Part of this bootstrap process may include the establishment of shared secret keys and rules that define the expected and/or allowed token types and identifier translations. In general, this bootstrapping process can be implemented out-of-band as this process may also include the establishment of business agreements that govern an enterprise's participation in a federation and the liabilities associated with this participation.

There are a number of possible mechanisms for establishing trust in a federated business model. In a federation model, a fundamental notion of trust between the federation participants is required for business reasons in order to provide a level of assurance that the assertions (including tokens and attribute information) that are transferred between the participants are valid. If there is no trust relationship, then the service provider cannot depend upon the assertions received from the identity provider; they cannot be used by the service provider to determine how to interpret any information received from the identity provider.

For example, a large corporation may want to link several thousand global customers, and the corporation could use non-federated solutions. As a first example, the corporation could require global customers to use a digital certificate from a commercial certificate authority to establish mutual trust. The commercial certificate authority enables the servers at the corporation to trust servers located at each of the global customers. As a second example, the corporation could implement third-party trust using Kerberos; the corporation and its global customers could implement a trusted third-party Kerberos domain service that implements shared-secret-based trust. As a third example, the corporation could establish a private scheme with a proprietary security message token that is mutually trusted by the servers of its global customers.

Any one of these approaches may be acceptable if the corporation needed to manage trust relationships with a small number of global customers, but this may become unmanageable if there are hundreds or thousands of potential federation partners. For example, while it may be possible for the corporation to force its smaller partners to implement a private scheme, it is unlikely that the corporation will be able to impose many requirements on its larger partners.

An enterprise may employ trust relationships established and maintained through trust proxies and possibly trust brokers. An advantage of the exemplary federated architecture that is shown in the figures is that it does not impose additional requirements above and beyond the current infrastructures of an enterprise and its potential federation partners.

However, this exemplary federation architecture does not relieve an enterprise and its potential federation partners from the preliminary work required to establish business and liability agreements that are required for participation in the federation. In addition, the participants cannot ignore the technological bootstrapping of a trust relationship. The exemplary federation architecture allows this bootstrapping to be flexible, e.g., a first federation partner can issue a Kerberos ticket with certain information, while a second federation partner can issue a SAML authentication assertion with certain information.

In the exemplary federation architecture, the trust relationships are managed by the trust proxies, which may include (or may interact with) a security token service that validates and translates a token that is received from an identity provider based on the pre-established relationship between two trust proxies. In situations where it is not feasible for a federated enterprise to establish trust relationships (and token translation) with another federated enterprise, a trust broker may be invoked; however, the federated enterprise would need to establish a relationship with a trust broker.

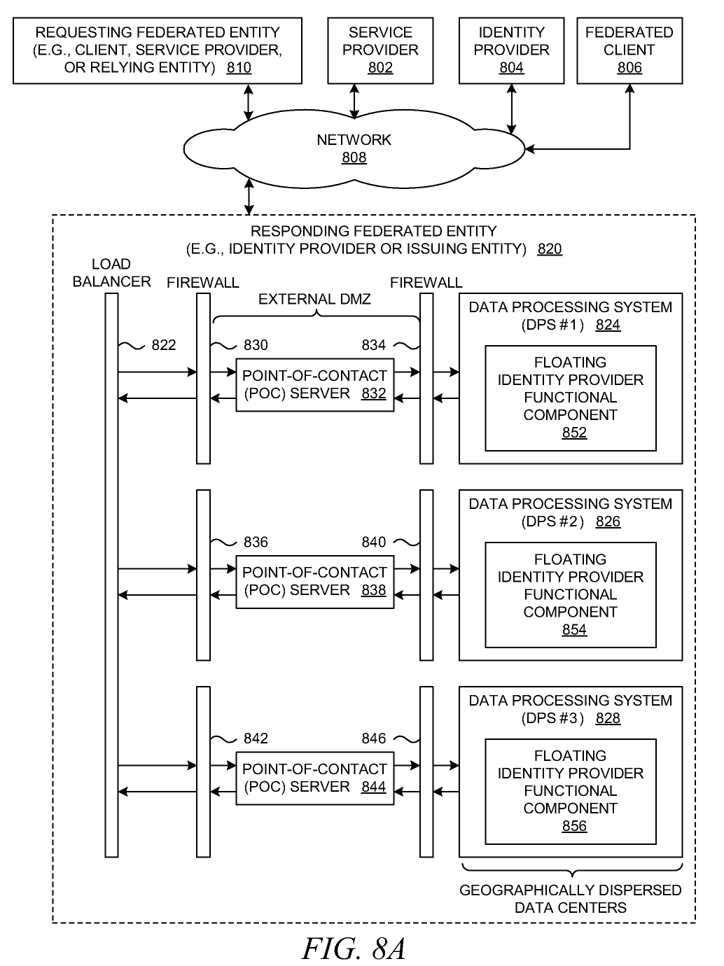

With reference now to FIG. 5, a block diagram depicts an exemplary set of trust relationships between federated domains using trust proxies and a trust broker in accordance with an exemplary federated architecture that is able to support the present invention. Although FIG. 4 introduced the trust broker, FIG. 5 illustrates the importance of transitive trust relationships within the exemplary federated architecture.

Federated domains 502-506 incorporate trust proxies 508-512, respectively. Trust proxy 508 has direct trust relationship 514 with trust proxy 510. Trust broker 520 has direct trust relationship 516 with trust proxy 510, and trust broker 520 has direct trust relationship 518 with trust proxy 512. Trust broker 520 is used to establish, on behalf of a federation participant, a trust relationship based on transitive trust with other federation partners. The principle of transitive trust allows trust proxy 510 and trust proxy 512 to have brokered trust relationship 522 via trust broker 520. Neither trust proxy 510 nor 512 need to know how to translate or validate the other's assertions; the trust broker may be invoked to translate an assertion into one that is valid, trusted, and understood at the other trust proxy.

Business agreements that specify contractual obligations and liabilities with respect to the trust relationships between federated enterprises can be expressed in XML through the use of the ebXML (Electronic Business using XML) standards. For example, a direct trust relationship could be represented in an ebXML document; each federated domain that shares a direct trust relationship would have a copy of a contract that is expressed as an ebXML document. Operational characteristics for various entities within a federation may be specified within ebXML choreographies and published within ebXML registries; any enterprise that wishes to participate in a particular federation, e.g., to operate a trust proxy or trust broker, would need to conform to the published requirements that were specified by that particular federation for all trust proxies or trust brokers within the federation. A security token service could parse these ebXML documents for operational details on the manner in which tokens from other domains are to be translated. It should be noted, though, that other standards and mechanisms could be employed to support the present invention for specifying the details about the manner in which the trust relationships within a federation are implemented.

Single-Sign-on within Federated Architecture

During a given user's session, the user may visit many federated domains to use the web services that are offered by those domains. Domains can publish descriptions of services that they provide using standard specifications such as UDDI and WSDL, both of which use XML as a common data format. The user finds the available services and service providers through applications that also adhere to these standard specifications. SOAP provides a paradigm for communicating requests and responses that are expressed in XML. Entities within a federated environment may employ these standards among others.

Within a federation, a user expects to have a single-sign-on experience in which the user completes a single authentication operation, and this authentication operation suffices for the duration of the user's session, regardless of the federation partners visited during that session. A session can be defined as the set of transactions from (and including) the initial user authentication, i.e. logon, to logout. Within a session, a user's actions will be governed in part by the privileges granted to the user for that session.

The federated architecture that is described hereinabove supports single-sign-on operations. To facilitate a single-sign-on experience, web services that support the federated environment will also support using an authentication assertion or security token generated by a third-party to provide proof of authentication of a user. This assertion will contain some sort of evidence of the user's successful authentication to the issuing party together with an identifier for that user. For example, a user may complete traditional authentication operation with one federation partner, e.g., by providing a username and password that the federation partners uses to build authentication credentials for the user, and then the federation partner is able to provide a SAML authentication assertion that is generated by the authenticating/issuing party to a different federation partner.

The federated environment also allows web services or other applications to request web services, and these web services would also be authenticated. Authentication in a web services environment is the act of verifying the claimed identity of the web services request so that the enterprise can restrict access to authorized clients. A user who requests or invokes a web service would almost always be authenticated, so the need for authentication within a federated environment that supports the present invention is not any different from current requirements of web services for user authentication.

Authentication of users that are accessing the computational resources of an enterprise without participating in a federated session are not impacted by the presence of a federated infrastructure. For example, an existing user who authenticates with a forms-based authentication mechanism over HTTP/S to access non-federated resources at a particular domain is not affected by the introduction of support at the domain for the federated environment. Authentication is handled in part by a point-of-contact server, which in turn may invoke a separate trust proxy or trust service component; the use of a point-of-contact server minimizes the impact on the infrastructure of an existing domain. For example, the point-of-contact server can be configured to pass through all non-federated requests to be handled by the back-end or legacy applications and systems at the domain.

The point-of-contact server may choose to invoke an HTTP-based authentication method, such as basic authentication, forms-based authentication, or some other authentication method. The point-of-contact server also supports a federation domain by supporting the processing of an assertion that has been presented by the user as proof of authentication, such as an SAML authentication assertion, wherein the assertion has crossed between enterprise domains; the single-sign-on protocol service is used to recognize an assertion/artifact when it is received in the context of a federation protocol. The point-of-contact server may invoke the trust service, which in turn may invoke its security token service for validation of authentication credentials/security tokens.

Authentication of web services or other applications comprises the same process as authentication of users. Requests from web services carry a security token containing an authentication assertion, and this security token would be validated by the trust service in the same manner as a token presented by a user. A request from a web service should be accompanied by this token because the web service would have discovered what authentication assertions/security tokens were required by the requested service as advertised in UDDI.

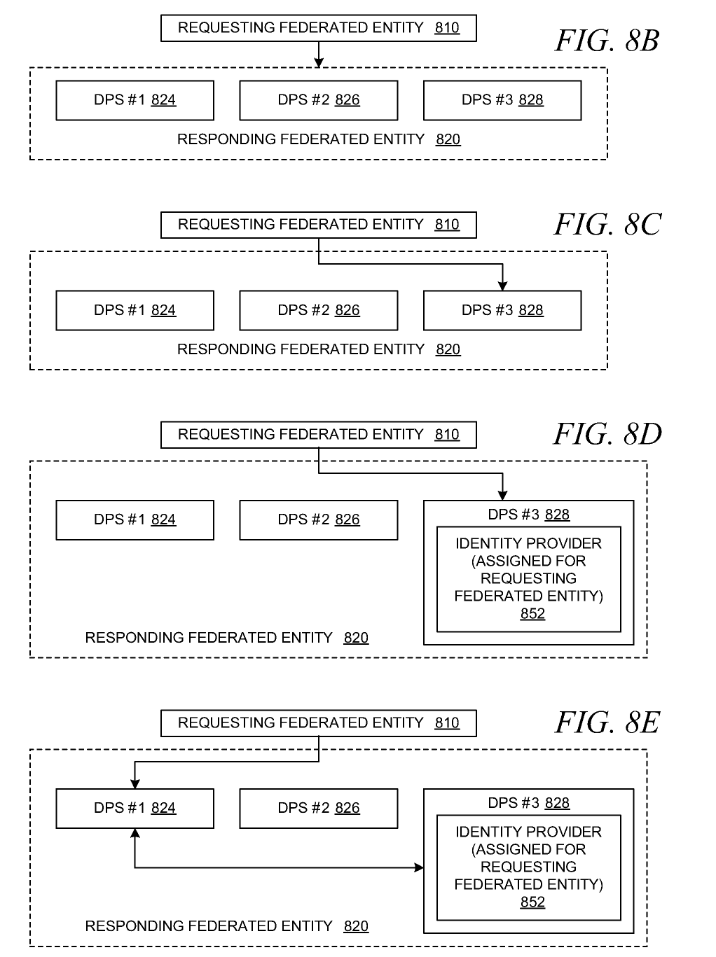

With reference now to FIG. 6, a block diagram depicts a federated environment that supports federated single-sign-on operations. User 600, through a client device and an appropriate client application, such as a browser, desires to access a web service that is provided by enterprise/domain 610, which supports data processing systems that act as a federated domain within a federated environment. Domain 610 supports point-of-contact server 612 and trust proxy or trust service 614; similarly, domain 620 supports point-of-contact server 622 and trust proxy or trust service 624, while domain 630 supports point-of-contact server 632 and trust proxy or trust service 634. The trust proxies/services rely upon trust broker 650 for assistance, as described above. Additional domains and trust proxies/services may participate in the federated environment. FIG. 6 is used to describe a federated single-sign-on operation between domain 610 and domain 620; a similar operation may occur between domain 610 and domain 630.

The user completes an authentication operation with respect to domain 610; this authentication operation is handled by point-of-contact server 612. The authentication operation is triggered when the user requests access to some resource that requires an authenticated identity, e.g., for access control purposes or for personalization purposes. Point-of-contact server 612 may invoke a legacy authentication service, or it may invoke trust proxy 614 to validate the user's presented authentication credentials. Domain 610 becomes the user's identity provider or home domain for the duration of the user's federated session.

At some later point in time, the user initiates a transaction at a federation partner, such as enterprise 620 that also supports a federated domain, thereby triggering a federated single-sign-on operation. For example, a user may initiate a new transaction at domain 620, or the user's original transaction may cascade into one or more additional transactions at other domains. As another example, the user may invoke a federated single-sign-on operation to a resource in domain 620 via point-of-contact server 612, e.g., by selecting a special link on a web page that is hosted within domain 610 or by requesting a portal page that is hosted within domain 610 but that displays resources hosted in domain 620. Point-of-contact server 612 sends a request to trust proxy 614 to generated a federation single-sign-on token for the user that is formatted to be understood or trusted by domain 620. Trust proxy 614 returns this token to point-of-contact server 612, which sends this token to point-of-contact server 622 in domain. Domain 610 acts as an issuing party for the user at domain 620, which acts as a relying party. The user's token would be transferred with the user's request to domain 620; this token may be sent using HTTP redirection via the user's browser, or it may be sent by invoking the request directly of point-of-contact server 622 (over HTTP or SOAP-over-HTTP) on behalf of the user identified in the token supplied by trust proxy 614.

Point-of-contact server 622 receives the request together with the federation single-sign-on token and invokes trust proxy 624. Trust proxy 624 receives the federation single-sign-on token, validates the token, and assuming that the token is valid and trusted, generates a locally valid token for the user. Trust proxy 624 returns the locally valid token to point-of-contact server 622, which establishes a session for the user within domain 620. If necessary, point-of-contact server 622 can initiate a federated single-sign-on at another federated partner.

Validation of the token at domain 620 is handled by the trust proxy 624, possibly with assistance from a security token service. Depending on the type of token presented by domain 610, the security token service may need to access a user registry at domain 620. For example, domain 620 may provide a binary security token containing the user's name and password to be validated against the user registry at domain 620. Hence, in this example, an enterprise simply validates the security token from a federated partner. The trust relationship between domains 610 and 620 ensures that domain 620 can understand and trust the security token presented by domain 610 on behalf of the user.

Federated single-sign-on requires not only the validation at the relying domain of the security token that is presented to a relying domain on behalf of the user but also, based on information contained in the security token, the determination of a locally valid user identifier and possibly attributes that are associated with this identifier. One result of a direct trust relationship and the business agreements that are required to establish such a relationship is that at least one party, either the issuing domain or the relying domain or both, will know how to translate the information provided by the issuing domain into an identifier that is valid at the relying domain; this identifier at the relying domain may be the result of a one-to-one mapping of the identity asserted by the issuing party or the result of another type of mapping, e.g., a many-to-one mapping of an identity to a role, i.e. it is not a requirement that this be a unique one-to-one mapping for local, issuing party identifiers. In the brief example above, it was assumed that the issuing domain, i.e. domain 610, is able to provide the relying domain, i.e. domain 620, with a user identifier that is valid in domain 620. In that scenario, the relying domain did not need to invoke any identity mapping functionality. Trust proxy 624 at domain 620 will generate a security token for the user that will “vouch-for” this user. The types of tokens that are accepted, the signatures that are required on tokens, and other requirements are all pre-established as part of the federation's business agreements. The rules and algorithms that govern identifier translation are also pre-established as part of the federation's business agreements and are defined by the agreed-upon policy for token management and exchange. In the case of a direct trust relationship between two participants, the identifier translation algorithms will have been established for those two parties and may not be relevant for any other parties in the federation.

However, it is not always the case that the issuing domain will know how to map the user from a local identifier for domain 610 to a local identifier for domain 620. In some cases, it may be the relying domain that knows how to do this mapping, while in yet other cases, neither party will know how to do this translation, in which case a third party trust broker may need to be invoked. In other words, in the case of a brokered trust relationship, the issuing and relying domains do not have a direct trust relationship with each other. They will, however, have a direct trust relationship with a trust broker, such as trust broker 650. Identifier mapping rules and algorithms will have been established as part of this relationship, and the trust broker will use this information to assist in the identifier translation that is required for a brokered trust relationship.

Domain 620 receives the token that is issued by domain 610 at point-of-contract server 622, which invokes trust proxy 624 to validate the token and perform identity mapping. In this case, since trust proxy 624 is not able to map the user from a local identifier for domain 610 to a local identifier for domain 620, trust proxy 624 invokes trust broker 650, which validates the token and performs the identifier mapping. After obtaining the local identifier for the user, trust proxy 624, possibly through its security token service, can generate any local tokens that are required by the back-end applications at domain 620, e.g., a Kerberos token may be required to facilitate single-sign-on from the point-of-contact server to the application server. After obtaining a locally valid token, if required, the point-of-contact server is able to build a local session for the user. The point-of-contract server may also handle coarse-grained authorization of user requests and forward the authorized requests to the appropriate application servers within domain 620.

Federated User Lifecycle Management

A portion of the above description of FIGS. 2-6 explained an organization of components that may be used in a federated environment while other portions explained the processes for supporting single-sign-on operations across the federated environment. Service providers or relying domains within a federated environment do not necessarily have to manage a user's authentication credentials, and those relying domains can leverage a single single-sign-on token that is provided by the user's identity provider or home domain. The description of FIGS. 2-6 above, though, does not explain an explicit process by which federated user lifecycle management may be accomplished in an advantageous manner at the federated domains of federation partners.

Federated user lifecycle management functionality/service comprises functions for supporting or managing federated operations with respect to the particular user accounts or user profiles of a given user at multiple federated domains; in some cases, the functions or operations are limited to a given federated session for the user. In other words, federated user lifecycle management functionality refers to the functions that allow management of federated operations across a plurality of federated partners, possibly only during the lifecycle of a single user session within a federated computing environment.

Each federated domain might manage a user account, a user profile, or a user session of some kind with respect to the functions at each respective federated domain. For example, a particular federated domain might not manage a local user account or user profile within the particular federated domain, but the federated domain might manage a local user session for a federated transaction after the successful completion of a single-sign-on operation at the federated domain. As part of the federated user lifecycle management functionality that is supported by that particular federated domain, the federated domain can participate in a single-sign-off operation that allows the federated domain to terminate the local user session after the federated transaction is complete, thereby improving security and promoting efficient use of resources.

In another example of the use of federated user lifecycle management functionality, a user may engage in an online transaction that requires the participation of multiple federated domains. A federated domain might locally manage a user profile in order to tailor the user's experience with respect to the federated domain during each of the user's federated sessions that involve the federated domain. As part of the federated user lifecycle management functionality that is supported by that particular federated domain, the information in the federated domain's local user profile can be used in a seamless manner during a given federated transaction with information from other profiles at other federated domains that are participating in the given federated transaction. For example, the information from the user's multiple local user profiles might be combined in some type of merging operation such that the user's information is visually presented to the user, e.g., within a web page, in a manner such that the user is not aware of the different origins or sources of the user's information.

Federated user lifecycle management functionality may also comprise functions for account linking/delinking. A user is provided with a common unique user identifier across federation partners, which enables single-sign-on and the retrieval of attributes (if necessary) about a user as part of the fulfillment of a request at one federation partner. Furthermore, the federation partner can request additional attributes from an identity provider using the common unique user identifier to refer to the user in an anonymous manner.

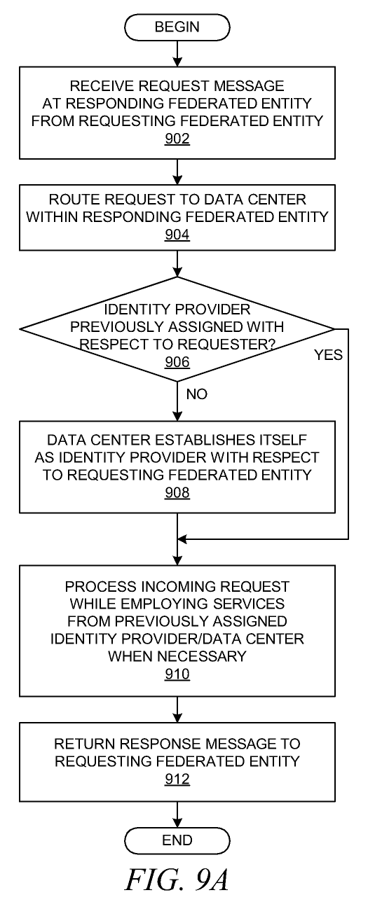

With reference now to FIG. 7, a block diagram depicts some of the components in a federated domain for implementing federated user lifecycle management functionality in order to support the present invention. FIG. 7 depicts elements at a single federated domain, such as the federated domain that is shown in FIG. 3. Some of the elements in FIG. 7 are similar or identical to elements that have been discussed hereinabove with respect to other figures, such as FIG. 3: point-of-contact server/service 702 is equivalent to point-of-contact server 342; application servers 704, which run services that control access to protected resources, are equivalent to application servers 334; protected or controlled resources 706 are equivalent to protected resources 335; and federated user lifecycle management (FULM) application 708 is equivalent to federated user lifecycle management application 352. Although firewalls were not illustrated within FIG. 3, firewalls are illustrated within FIG. 7. Firewall 710 and firewall 712 create an external DMZ (electronic DeMilitarized Zone) that protects the enterprise's computing environment from computing threats outside of the enterprise's domain, e.g., via the Internet.

The different perspectives that are shown in FIG. 3 and FIG. 7 are not incompatible or at cross-purposes. In contrast with the example that is shown in FIG. 7, FIG. 3 does not illustrate the firewalls, yet point-of-contact server 342 resides within federation front-end 340; in addition, federated user lifecycle management application 352 is contained within federation front-end 340. In FIG. 7, point-of-contact server 702 is illustrated as residing within the DMZ between firewalls 710 and 712, which form an electronic or physical front-end to the enterprise domain; in addition, federated user lifecycle management application/service 708 resides electronically behind firewall 712. Trust service 714, single-sign-on protocol service 716, and identity-and-attribute service 718 employ enterprise user registry 720 and federation user registry 722 as necessary. The different perspectives of FIG. 3 and FIG. 7 can be reconciled by regarding federation front-end 340 and back-end 330 in FIG. 3 as a logical organization of components while regarding the DMZ and the other components in FIG. 7 as forming a physical or electronic front-end and a physical or electronic back-end, either of which may contain federated components.

Reiterating the roles of a point-of-contact entity/service, the point-of-contact entity provides session management, at least with respect to a user's interaction with the federation functionality with an enterprise's computing environment; applications within a legacy back-end of the enterprise's computing environment may also implement its own session management functionality. Assuming that an enterprise implements policy functionality with respect to the federated computing environment, the point-of-contact entity may act as a policy enforcement point to some other federation partner's policy decision point. In addition, assuming that it is permissible given the implementation of the federation functionality, the point-of-contact entity is responsible for initiating a direction authentication operation against a user in those scenarios in which a single-sign-on operation is not employed. As such, the point-of-contact entity may be implemented in a variety of forms, e.g., as a reverse proxy server, as a web server plug-in, or in some other manner. The point-of-contact functionality may also be implemented within an application server itself, in which case the federated user lifecycle management services may be logically located within the DMZ.

More importantly, referring again to FIG. 7, federated user lifecycle management application 708 also comprises support for interfacing to, interacting with, or otherwise interoperating with federated user lifecycle management plug-ins 724, which are not shown in FIG. 3. In the exemplary architecture that is shown in FIG. 7, federated protocol runtime plug-ins provide the functionality for various types of independently published or developed federated user lifecycle management standards or profiles, such as: WS-Federation Passive Client; and Liberty Alliance ID-FF Single Sign On (B/A, B/P and LECP), Register Name Identifier, Federation Termination Notification, and Single Logout. Different sets of federated protocols may be accessed at different URI's. This approach allows the federated user lifecycle management application to concurrently support multiple standards or specifications of federated user lifecycle management, e.g., the WS-Federation web services specification versus the Liberty Alliance's specifications, within a single application, thereby minimizing the configuration impact on the overall environment for supporting different federation protocols.

More specifically, the appropriate federated user lifecycle management functionality is invoked by the point-of-contact server by redirecting and/or forwarding user requests to the federated user lifecycle management application as appropriate. Referring again to FIG. 7, point-of-contact server 702 receives user requests 730, which are then analyzed to determine the type of request that has been received, which might be indicated by the type of request message that has been received or, as noted above, by determining the destination URI within the request message. While requests 732 for protected resources continue to be forwarded to application servers 704, requests 734 for federated user lifecycle management functions, e.g., requests to invoke a single-sign-off operation, are forwarded to federated user lifecycle management application 708, which invokes the appropriate federated user lifecycle management plug-in as necessary to fulfill the received request. When a new federation protocol or a new federated function is defined, or when an existing one is somehow modified or refined, support can be added simply by plugging a new support module or can be refined by modifying a previously installed plug-in.

The exemplary implementation of a federated user lifecycle management application in FIG. 7 illustrates that the federated user lifecycle management application is able to support multiple, simultaneous, federated user lifecycle management functions while providing a pluggability feature, thereby allowing new functionality to be added to the federated user lifecycle management application in the form of a plug-in when needed without requiring any changes to the existing infrastructure. For example, assuming that the present invention is implemented using a Java™-based federated user lifecycle management application, support for a new federation protocol, such as a newly published single-sign-on protocol, can be added by configuring newly developed Java™ classes to the Java™ CLASSPATH of the federated user lifecycle management application, wherein these new classes support the new standard along with the protocol interface for supporting the present invention.

The exemplary federated architecture leverages the existing environment in which a federated user lifecycle management solution is to be integrated. The federated user lifecycle management application can be easily modified to support new protocols/standards as they evolve with minimal changes to the overall infrastructure. Any changes that might be required to support new federated user lifecycle management functionality are located almost exclusively within the federated user lifecycle management application, which would require configuring the federated user lifecycle management application to understand the added functionality.

There may be minimal configuration changes in other federated components, e.g., at a point-of-contact server, in order to allow the overall infrastructure to be able to invoke new federated user lifecycle management functionality while continuing to support existing federated user lifecycle management functionality. However, the federated user lifecycle management applications are functionally independent from the remainder of the federated components in that the federated user lifecycle management applications may require only minimal interaction with other federated components of the federated environment. For example, in an exemplary embodiment, the federated user lifecycle management functionality may integrate with an enterprise-based datastore, e.g., an LDAP datastore, if federated user lifecycle management information, such as NameIdentifier values in accordance with the Liberty Alliance profiles, are to be stored in an externally-accessible federated user lifecycle management datastore as opposed to a private, internal, federated user lifecycle management datastore that is not apparent or accessible to external entities.

Hence, an existing environment needs minimal modifications to support federated user lifecycle management functionality. Moreover, changes to federated user lifecycle management functionality, including the addition of new functionality, have minimal impact on an existing federated environment. Thus, when a new single-sign-on standard is published, support for this standard is easily added.

Traditional user authentication involves interaction between an enterprise's computing environment and the end-user only; the manner in which the enterprise chooses to implement this authentication interchange is the choice of the enterprise, which has no impact on any other enterprise. When federation or cross-domain single-sign-on functionality is desired to be supported, however, it becomes a requirement that enterprise partners interact with each other. This requirement cannot be done scalably using proprietary protocols. Although adding support for standards-based federation protocols directly to a point-of-contact entity seems like a robust solution, the point-of-contact entity, which is already an existing component within the enterprise's computing environment, must be modified; moreover, it must be modified every time that one of these public federation protocols changes. Moving this functionality out of the point-of-contact entity provides a more modular approach, wherein this pluggable functionality makes it easy to maintain migrations or updates to these protocols.

Implementation of a Floating Identity Provider within a Distributed Data Processing System

As noted further above, there is a tradeoff that should be considered in the implementation of federated protocol operations. Some operations, such as those that might require minimal interaction with the user to complete an operation, should be performed in a manner that is minimally burdensome on the user, but they should also be performed in a manner that is efficient for the federated enterprises, particularly for those types of operations that might be required across all users within an enterprise. With respect to operations that are required in order to support certain federated protocols, a federated enterprise may not have much flexibility in the manner in which those operations are implemented and the resulting burdens on the users and on the federated enterprise's computational resources. A federated enterprise may be required to perform certain actions in certain ways in accordance with federation specifications to which the federated enterprise has agreed. In other words, a federated enterprise may be required by business contracts to implement certain federation operations without regard to the computational burden of those operations.

However, many aspects of functionality within a federated environment could be categorized as operations that support one or more business goals that are desired by one or more enterprises within a federation yet are not necessarily required to support federation protocols or that are not necessarily required in order to participate within a federation. Since the resulting actions for supporting an enterprise-specific business goal may have ramifications across a federated environment, the manner in which the supporting operations are implemented should be accomplished in a manner that is scalable across thousands or millions of users within a federation. A system administrator with responsibilities of managing federated functionality within an enterprise should be able to configure its computational resources in an efficient manner when implementing the desired business goals of the enterprise.

As noted above, one manner of addressing the burden on computational resources within a federated enterprise is to implement the federated functionality within a distributed data processing system. However, the characteristics of a distributed data processing system may be problematic; some of the requirements of federated protocols would complicate the implementation of the functionality for performing those federated protocols within a distributed data processing system. For example, the services of an identity provider could be supported within a distributed data processing system, but in prior art implementations, identity providers are statically assigned to clients or service providers in a manner that is not amenable to implementing them within a distributed data processing system.

To improve prior art implementations of identity providers, the present invention provides a distributed computational infrastructure for efficient management of federated protocol operations, particularly with respect to implementing an identity provider within a distributed data processing system. The present invention allows a federated entity, such as a service provider, to be directed to an appropriate data processing system or data center that redundantly provides the functionality of an identity provider within a larger distributed data processing system while still allowing the advantages of a distributed data processing system, such as load factoring. The approach of the present invention provides flexible assignment of resources for implementing an identity provider while providing a federated entity with the functionality that is expected from an identity provider.

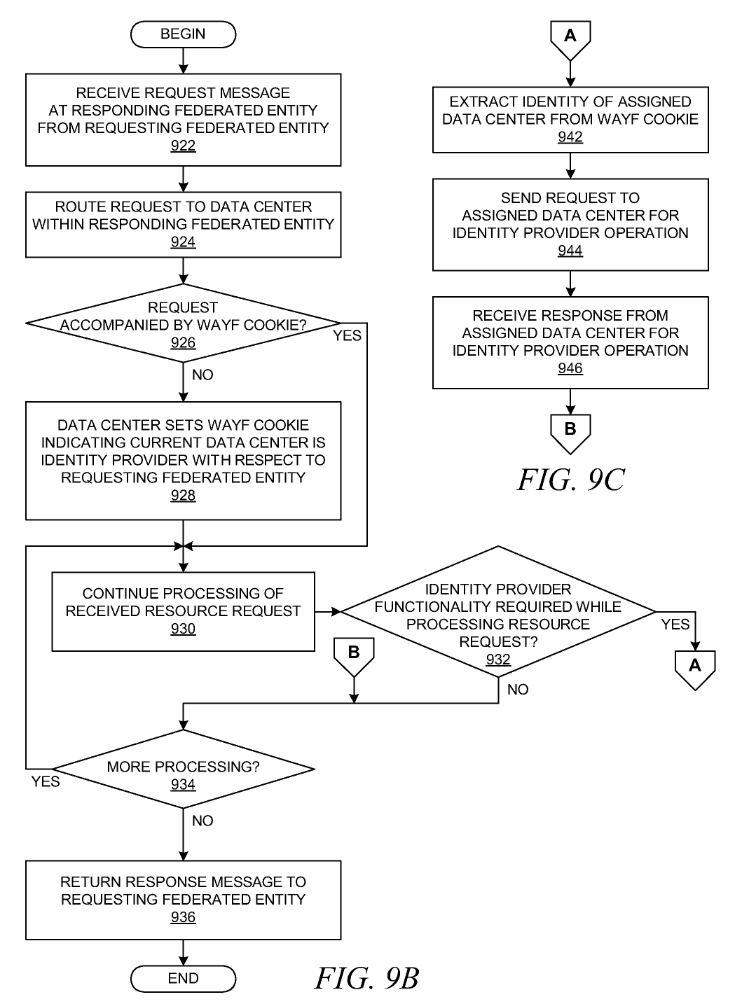

With reference now to FIG. 8A, a block diagram depicts a federated entity that is implemented as a distributed data processing system to support flexible assignment of resources for implementing identity provider functionality in accordance with an embodiment of the present invention. FIG. 8A shows multiple federated entities within a federated computational environment, i.e. a federation. Federated entities may include service providers, such as service provider 802, identity providers, such as identity provider 804, and clients, such as client 806, that are supported by or interact with various federated service providers, federated identity providers, or other federated entities, all of which communicate through one or more networks within the federated space, such as network 808. Federated entity 810 is a generalized entity within the federated environment that may represent a service provider, an identity provider, or a typical federated client, depending upon the type of federated operation that is occurring.

Federated entity 820 generally interacts with other federated entities, such as federated entity 810. Although the example that is shown in FIG. 8A focuses on the fact that federated entity 820 includes functionality for acting as an identity provider, it should be noted that federated entity 820 may include additional federated functionality, such as that which is associated with a service provider or some other type of federated entity, depending upon the type of federated operation that is occurring. For example, federated entity 820 may generate data objects that include security-related data objects, such as authentication credentials or user attribute assertions, or the data objects may include media content, scientific data, or some other type of generalized data. From this perspective, federated entity 810 can be generally viewed as a requesting federated entity that submits request messages to access resources at federated entity 820, and federated entity 820 can be viewed as a responding federated entity that returns response messages with data to federated entity 810. In a typical operation, as requested or required, federated entity 820 may issue assertions, e.g., SAML assertions, which were discussed hereinabove. Federated entity 810 may employ those assertions for various federated protocol operations/profiles in accordance with one or more specifications for different federated computational environments, e.g., to accomplish a federated single-sign-on authentication operation.

Turning now to discuss more important novel aspects of the present invention, FIG. 8A also illustrates an embodiment of a federated entity in accordance with the present invention in which the federated entity is organized as a distributed data processing system that supports distributed functionality for performing operations as an identity provider. In order to distribute its processing load, federated entity 820 optionally employs load balancer 822, which receives and forwards incoming request messages, such as requests for the performance of operations in accordance with federation protocols, amongst multiple data processing systems, such as data processing system 824, data processing system 826, and data processing system 828; hence, federated entity 820 is a distributed data processing system having a set of multiple data processing systems 824-828. Load balancer 822 may employ various well-known algorithms to distribute the workload amongst multiple data processing systems, including geographic distribution, e.g., in which the requests from a user in a given region are directed to a data center within the same geographic region.

Data traffic to/from the multiple data processing system passes through firewalls and point-of-contact servers in a manner that is similar to what is shown in FIG. 7. Data traffic for data processing system 824 passes through firewall 830, point-of-contact server 832, and firewall 834. Data traffic for data processing system 826 passes through firewall 836, point-of-contact server 838, and firewall 840. Data traffic for data processing system 828 passes through firewall 842, point-of-contact server 844, and firewall 846. In one embodiment of the present invention, data processing systems 824-828 and their associated infrastructures may represent geographically dispersed data centers, thereby allowing load balancer 822 to distribute the data traffic and the associated processing load amongst data processing systems 824-828 in a manner that is geographically appropriate for the origination of resource requests and the location of data processing systems 824-828. In the case of geographically distributed data centers, firewall 836, point-of-contact server 838, and firewall 840 may in turn be representative of a set of machines that have been replicated to ensure high levels of availability within the data center.

Although not shown in detail in FIG. 8A, data processing systems 824-828 contain functionality for handling federated protocol operations/profiles that have been discussed above with respect to other figures, e.g., as represented by federation front-end 340 in FIG. 3 and by components behind firewall 712 in FIG. 7. For example, each of data processing systems 824-828 contain federated user lifecycle management (FULM) components that are similar to FULM 352 in FIG. 3 and FULM 708 in FIG. 7.

More importantly, each data processing system, e.g., data processing system 824, within a set of data processing systems, e.g., data processing systems 824-828, in the distributed computational environment of a responding federated entity, e.g., federated entity 820, can be configured to include the functionality of an identity provider that is flexibly or dynamically assignable with respect to a given requesting federated entity. In other words, each data processing system within a set of data processing systems in the distributed computational environment of a responding federated entity comprises the ability to function as an identity provider, yet a given requesting federated entity is temporally assigned to a specific data processing system within the set of data processing systems in the distributed computational environment. The association or assignment of a requesting federated entity and a data processing system that is selected as its identity provider is preferably temporally configurable; the association or assignment expires after a configurable time period. Hence, the association between a specific requesting federated entity and an assigned data processing system preferably is not permanent. In addition, there is preferably no predetermined assignment of one of the responding federated entity's data processing systems to a specific requesting federated entity; for example, there is no predetermined assignment prior to the receipt of a resource request from the requesting federated entity at the responding federated entity, and there is no predetermined assignment after the expiration of the configurable time period. In this manner, the dynamic characteristic of the assignment of identity provider functionality within the responding, distributed, federated entity can be viewed as floating amongst the data processing systems within the set of data processing systems in the distributed computational environment of a responding federated entity. In other words, the flexible assignment of the identity provider functionality of a data processing system within the distributed computational environment of federated entity is said to float.

As shown in FIG. 8A, data processing systems 824, 826, and 828 contain floating identity provider functional components 850, 852, and 854, respectively. A floating identity provider functional component comprises the ability to function or act as an identity provider while also comprising the ability to allow the floating or dynamic assignment characteristic that is mentioned above. In other words, data processing systems 824, 826, and 828 comprise hardware and/or software for supporting the functionality of an identity provider in a manner in which the identity provider functionality of a given data processing system may be flexibly assigned to perform operations as requested by a requesting federated entity in a dynamic manner in accordance with the present invention, as explained in more detail below.

A more detailed example for some of the actions that occur such that the present invention may be employed to support a floating assignment of the identity provider functionality is shown in FIGS. 8B-8E. It should be noted that, although the present invention is applicable to generalized federation operations for a variety of federated protocols and a variety of federated operations, some exemplary federated operations are used to illustrate the floating identity provider functionality; more specifically, an example is discussed further below in which a specific federation operation is represented by a federated single-sign-on operation.

With reference now to FIGS. 8B-8E, block diagrams depict a scenario in which a first federated entity interacts with a second federated entity that is implemented using a distributed data processing system to support a floating identity provider in accordance with an embodiment of the present invention. FIGS. 8B-8E depicts some elements of a federated entity in a manner that is similar to federated entity 820 that is shown in FIG. 8A such that identical reference numerals refer to identical elements.

Referring now to FIG. 8B, federated entity 810 sends a resource request to federated entity 820. At the point in time that is illustrated in FIG. 8B, federated entity 820 has not yet determined to which data processing system within federated entity 820 to send the incoming resource request in order to fulfill the request, i.e. to respond to the request. Moreover, federated entity 820 has not yet determined whether or not a response to the resource request requires the completion of any federation-related operations; hence, none of the data processing systems within federated entity 820 have been selected to provide the functionality of an identity provider with respect to federated entity 810.

At some point in time, the resource request is examined and then sent or forwarded to one of the data processing systems that comprise the distributed data processing system of federated entity 820. Referring now to FIG. 8C, federated entity 820 has internally routed the incoming resource request to data processing system 828, possibly in accordance with configured policies, computational requirements, or other reasons. For example, a load balancer may have directed the incoming request to data processing system 828 in accordance with the current state of a load balancing algorithm. Alternatively, it may have been determined that the incoming request requires the use of a protected resource that is only available from data processing system 828 and is not available from data processing systems 824 nor 826. In any case, at the point in time that is illustrated in FIG. 8C, data processing system 828 may or may not have determined whether or not a response to the resource request requires the completion of any federation-related operations or whether or not the services of an identity provider are required.

At some point in time, though, data processing system 828 determines that a response to the resource request requires the completion of at least one federation-related operation and that the services of an identity provider are required, i.e. that the services of an identity provider functional component are required. Moreover, data processing system 828 determines that a data processing system with its identity provider functionality has not yet been assigned to federated entity 810.

Given that each data processing system 824-828 contains functionality for performing the federation-related operations of an identity provider, and given that data processing system 828 is already processing a request that requires the services of an identity provider, data processing system 828 assigns or otherwise establishes itself as an identity provider that is to be used to fulfill any need for services of an identity provider with respect to federated entity 810, including the request that is currently being processed and any subsequent requests for a configurable time period. Referring now to FIG. 8D, data processing system 828 has established itself to act as the identity provider that is to be used with respect to requesting federated entity 810. This self-assignment as the identity provider for federated entity 810 is valid for any subsequent requests that are received from federated entity 810 within a time period that is preferably configurable. The temporal validity of the assignment may vary with different implementations of the present invention in accordance with various policies of federated entity 820 or with various enterprise goals of the organization that operates federated entity 820.

Referring now to FIG. 8E, federated entity 810 has sent another resource request to federated entity 820. Federated entity 820 has internally routed the incoming resource request to data processing system 828, again, possibly in accordance with computational requirements, e.g., because the incoming request requires the use of a protected resource that is only available from data processing system 824 and that is not available from data processing systems 826 nor 828. In contrast to the processing of an incoming request as shown in FIG. 8D, at the point in time that is shown in FIG. 8E, FIG. 8E shows that data processing system 824 can determine that data processing system 828 has already been selected, assigned, or otherwise established as the data processing system that is to be employed to provide the services of an identity provider with respect to the processing of requests from federated entity 810. At some subsequent point in time thereafter, data processing system 824 can employ data processing system 828 and its floating identity provider functionality 852 as necessary to obtain the services of an identity provider for the current incoming resource request from federated entity 810. The manner in which data processing system 824 requests identity provider operations from data processing system 828 may vary; for example, data processing system 824 may send a request message to data processing system 828, but depending on the protocol, these messages may need to be redirected via the requesting federated entity, as discussed hereinbelow with respect to an example in another figure.

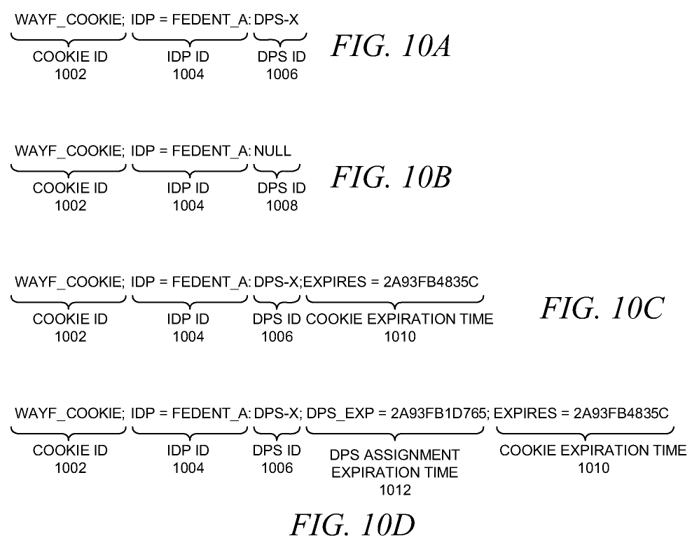

With reference now to FIGS. 9A-9C, a pair of flowcharts depict a process for handling a resource request within a federated entity that supports the assignment of a floating identity provider in accordance with an embodiment of the present invention. The process that is illustrated shows the computational steps that may be performed to accomplish the example that is described above with respect to FIGS. 8B-8E.

Referring to FIG. 9A, a resource request is received at a responding federated entity from a requesting federated entity (step 902). The responding federated entity routes the request to one of the data centers/data processing systems within a set of data processing systems in the distributed computational environment of the responding federated entity (step 904). The current data center, i.e. the data processing system that receives and processes the incoming request, determines whether or not one of the data processing systems within the distributed computational environment of the responding federated entity has already been assigned to provide the services of an identity provider with respect to the requesting federated entity (step 906). If a data processing system has not yet been assigned to function as an identity provider with respect to the requesting federated entity, then the current data center establishes itself as the data processing system that is assigned to provide the functionality of an identity provider with respect to the requesting federated entity (step 908). If it is determined at step 906 that a data center has previously been assigned, then the process branches for those instances because no assignment is required at step 908.

The incoming request from the requesting federated entity is then processed further in order to generate a response; while the request is being processed, the previously assigned data center for the given requesting federated entity is employed for its identity provider functionality as necessary (step 910). After the incoming request is processed, a response is generated, and the responding federated entity returns a response message to the requesting federated entity (step 912), thereby concluding the process.

Referring to FIG. 9B, the process that is illustrated in FIG. 9B is similar to the process that is illustrated in FIG. 9A. In FIG. 9A, the flowchart describes a process in which a data processing system within the responding federated entity generally determines the assignment of a data processing system at step 906 or generally establishes itself as the assigned data processing system at step 908. In contrast, FIG. 9B depicts a more specific process in which a cookie mechanism is used in determining the assignment or in establishing the assignment. In other words, FIG. 9B depicts a specific implementation of the present invention that uses cookies to indicate the previous assignment of a data center that is to act as the identity provider with respect to a requesting federated entity.

A resource request is received at a responding federated entity from a requesting federated entity (step 922). The responding federated entity routes the request to one of the data centers/data processing systems within a set of data processing systems in the distributed computational environment of the responding federated entity (step 924). The current data center, i.e. the data center that is currently processing the received resource request, determines whether the received resource request was received with, or otherwise accompanied by, a WAYF (Where Are You From) cookie (step 926). In other words, in the embodiment of the present invention that is shown in FIG. 9B, the existence of the WAYF cookie is equivalent to the existence of an assignment of a data center for acting as an identity provider with respect to the requesting entity. Hence, the current data center determines whether or not a data center within the distributed data processing system in which it is a member, e.g., data processing system 824 as shown in FIG. 8A, has been previously assigned to act as an identity provider with respect to the requesting federated entity by determining whether or not the incoming request is accompanied by, or otherwise associated with, a valid, specific type of cookie that may be termed a WAYF (Where Are You From) cookie. If so, then another WAYF cookie is not created or set. However, if a WAYF cookie is not obtained or received, or if the obtained or received WAYF cookie is invalid for some reason, then a WAYF cookie is created or set (step 928). The WAYF cookie is handled in such a manner that it is used for subsequent resource requests and is also associated with the resource request that is currently being processed, e.g., so that it is set and is available in the processing of the resource request that is currently being fulfilled.

In one embodiment of the present invention, a WAYF cookie can be viewed as a DDPS-ID cookie, i.e. a distributed data processing system (DDPS) identifier (ID) cookie. The content of the WAYF cookie identifies or otherwise indicates the particular data processing system or data center, i.e. within the distributed data processing system having a set of data processing systems, which has established itself during the processing of a resource request as the self-assigned data center that will subsequently act to provide the services of an identity provider with respect to the requesting federated entity. The WAYF cookie is returned by the requesting federated entity along with the response to the current resource request or in response to subsequent resource requests; in so doing, the WAYF cookie would be cached by the appropriate client application for accompaniment of subsequent resource request messages to the responding federated entity. Since the WAYF cookie is created or set by the data center/data processing system within the responding federated entity, i.e. within the distributed data processing system, that assigned itself to act as an identity provider for the requesting federated entity, the WAYF cookie can be viewed as demarcating from where it was issued, thereby indicating the data center/data processing system that should be used for identity provider operations during the valid time period of the WAYF cookie.

The current data center then continues the processing of the received resource request (step 930). Steps 930-934 can be viewed as a processing loop. At some point in time or at multiple points in time while the resource request is being processed, one or more determinations are made about whether or not the services of an identity provider are required (step 932), i.e. whether or not an operation needs to be performed by an identity provider, and the process branches accordingly. If no identity operation was required or after it has been performed, then a check is made as to whether there is more processing that should be done for the current resource request (step 934); if so, then the process branches back to step 930. At some point in time, the processing of the resource request would be completed, and the current data center would send a response message to the requesting federated entity (step 936), thereby concluding the process that is shown in FIG. 9B.

Referring now to FIG. 9C, if it is determined that the services of an identity provider are required at step 932 in FIG. 9B, then the current data center uses the WAYF cookie that was received, obtained, or associated with the current resource request; the current data center extracts an indication or an identifier of the data center/data processing system that generated the WAYF cookie (step 942), i.e. the data center that assigned itself to provide the functionality of an identity provider with respect to the federated entity. The current data center then sends a request to the assigned data center (step 944); the request message would be formatted as required by a given federation protocol to request the performance of a particular function by an identity provider. At some point in time, a response for the identity provider function would be received by the current data center from the assigned data center (step 946), and the result of that performed function would assist in the fulfillment of the processing of the current resource request, which may require additional processing at step 936, which may yet again require additional assistance by the data center that is acting as the identity provider. At some point in time, though, the processing of the resource request would be completed, and the current data center would send a response message to the requesting federated entity, thereby concluding the process.

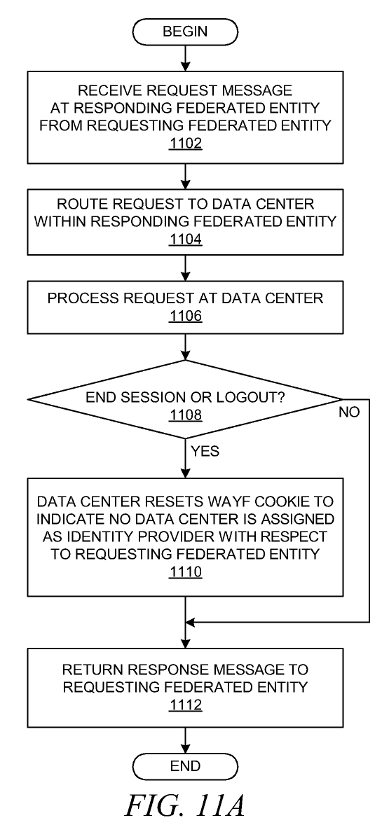

With reference now to FIGS. 10A-10D, a set of text strings depict some of the information that may be embedded within a cookie to support the assignment of a floating identity provider in accordance with an embodiment of the present invention. It should be noted that other text strings or substrings may also be present within the cookie, such as “name=”, as required by the communication protocol, e.g., such as HTTP, that is employed in a system that implements the present invention. For example, the domain name of the federated entity that has generated the cookie would be included, thereby informing a client application as to which domain should receive the cookie when a resource request is sent to the domain.

Referring now to FIG. 10A, an initial text string is cookie identifier 1002; this text string indicates that the cookie is a WAYF cookie, and it may be used as the name of the cookie. The second text string is identity provider (IdP) identifier 1004; this text string indicates that a particular federated entity, such as federated entity 820 as shown in FIG. 8A, is acting in some manner as an identity provider for requests that are accompanied by the WAYF cookie, thereby distinguishing that federated entity 820 has generated the WAYF cookie rather than many other possible identity providers within a federation.

Cookie ID 1002 and identity provider ID 1004 may allow interoperability with other systems that employ WAYF cookies in prior art solutions. However, the present invention provides additional information that is embedded in the WAYF cookie to enable a system to support novel processing of the WAYF cookie in accordance with the present invention. More specifically, the third text string is data processing system ID 1006 or data center ID 1006; this text string indicates the data center amongst a set of data centers that has assigned itself to act as the identity provider with respect to a requesting federated entity, as described above. It should be noted that the formatting of the text strings, the order of the text strings, and other information may be varied in different implementations of the present invention.

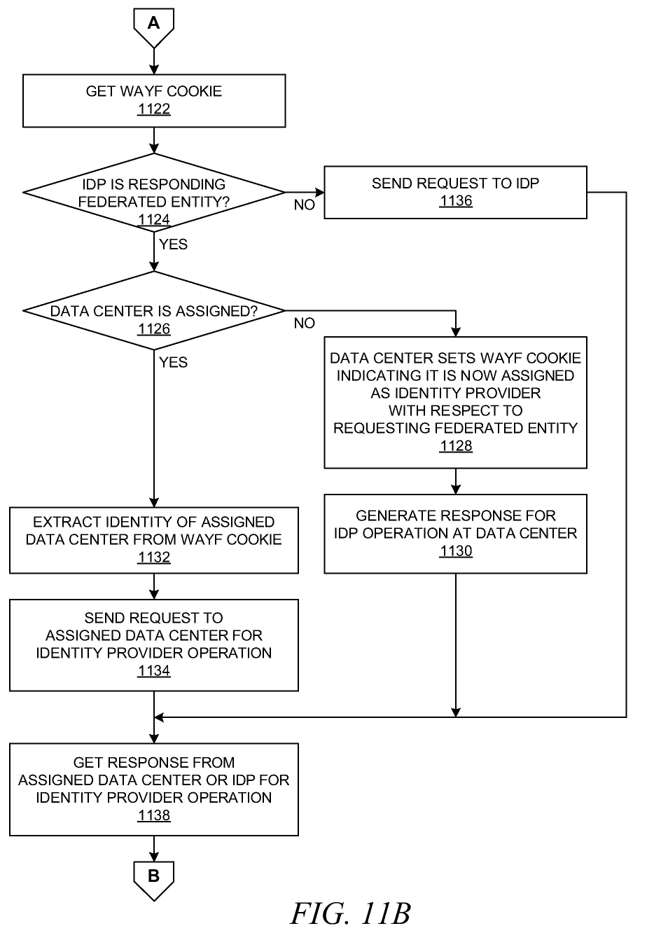

Although the process that is shown in FIG. 9B illustrates an embodiment in which the existence of a WAYF cookie may be interpreted as being equivalent to existence of an assignment of a data center as an identity provider, an alternative embodiment may allow the WAYF cookie to be used without an assignment of a data center as an identity provider. In other words, the WAYF cookie may be used to maintain an identification of the responding federated entity as the federated entity that acts as the identity provider with respect to a requesting federated entity, but no particular data center within the distributed computational environment of the responding federated entity is assigned to perform the identity provider functionality. Referring now to FIG. 10B, this scenario would be supported by the content of the WAYF cookie that is shown in FIG. 10B, wherein text string 1008 contains a data center ID value that has been set to “NULL” or some other representation of an empty value. The manner in which this may occur and may be used is described hereinbelow with respect to FIGS. 11A-11B.

In a manner similar to expiration values on other types of cookies, the WAYF cookie preferably has an expiration timestamp or similar datum that indicates a temporary validity period for the WAYF cookie, e.g., a limited number of hours. Referring now to FIG. 10C, text string 1010 indicates an expiration time for the WAYF cookie, e.g., as a hexadecimal value that represents a time value.

As mentioned above with respect to FIG. 10B, there may be implementations of the present invention in which it is useful to employ a WAYF cookie yet no particular data center within the distributed computational environment of the responding federated entity is assigned to perform the identity provider functionality. In addition, in one embodiment of the present invention, a time limit may be placed on the assignment of a data center as the identity provider; after the time limit has expired, the data center assignment is nullified. To enable this functionality, the WAYF cookie may be configured to support the expiration of a data center assignment by containing an expiration time value specifically for that purpose. Referring to FIG. 10D, text string 1012 indicates an expiration time for the data center assignment, e.g., as a hexadecimal value that represents a time value. In this manner, DPS assignment expiration value 1012 indicates the expiration of the content of the WAYF cookie with respect to any information in the WAYF cookie that relates to the data center assignment, e.g., an identifier of a data center and any other related information that may be stored in the WAYF cookie. If a data center receives a resource request along with a WAYF cookie in which DPS assignment expiration value 1012 indicates that the DPS assignment has expired, then the receiving data may assign itself as the data center for performing the identity provider functionality; this data center may then modify the WAYF cookie to include its identifier so that the WAYF cookie indicates that that data center is now the assigned data center.

With reference now to FIGS. 11A-11B, a pair of flowcharts depict processes for resetting an assignment of a floating identity provider in accordance with an embodiment of the present invention. Referring to FIG. 11A, a process is shown that commences in a manner similar to the process that is shown in FIG. 9A or FIG. 9B. A resource request is received at a responding federated entity from a requesting federated entity (step 1102). The responding federated entity routes the request to one of the data centers/data processing systems within a set of data processing systems in the distributed computational environment of the responding federated entity (step 1104), which then processes the request (step 1106).

While processing the request, a determination is made as to whether the session with the first federated entity is being terminated, or similarly, whether a logoff operation has been performed with respect to the first federated entity (step 1108); this may have included processing at the data center that is assigned to act as the identity provider with respect to the requesting federated entity. If the session for the requesting federated entity is being terminated in some manner, e.g., the requesting federated entity is being logged out, then the information in the WAYF cookie is modified to reflect that an assigned data center is no longer necessary. In other words, the process supports an alternative embodiment, as mentioned above with respect to FIG. 10B, that may allow the WAYF cookie to be used without an assignment of a data center as an identity provider; the WAYF cookie may continue to be used to maintain an identification of the responding federated entity as the federated entity that acts as the identity provider with respect to a requesting federated entity, but no particular data center within the distributed computational environment of the responding federated entity is assigned to perform the identity provider functionality. Hence, the WAYF cookie is modified to clear or reset the identity of the assigned data center (step 1110) such that the WAYF cookie does not contain an identifier or indicator of an assigned data center. At some point, a response message is eventually returned to the requesting federated entity along with the WAYF cookie (step 1112), thereby concluding the process.

The process that is shown in FIG. 11A resets an assignment of a data center as an identity provider. In contrast, FIG. 11B illustrates a process or subprocess for using a WAYF cookie in which an identifier for a data center acting as an identity provider has been reset. The process that is shown in FIG. 11B is employed while a resource request is being fulfilled by the responding federated entity, e.g., as shown in FIG. 9B. In other words, the process that is shown in FIG. 11B may be integrated into the process that is shown in FIG. 9B, as indicated by the flowchart connector elements in the figures. Hence, the process that is shown in FIG. 11B can be viewed as an alternative embodiment of the present invention when compared with the process that is shown in FIG. 9C.

Referring to FIG. 11B, the process commences by obtaining the WAYF cookie (step 1122) and examining it, e.g., while processing a resource request, as at step 930, and after determining that the services of an identity provider are required, as at step 932. A determination is made as to whether the WAYF cookie indicates that the responding federated entity, as opposed to some other federated entity within the federation, is acting as the identity provider with respect to the requesting federated entity (step 1124). If so, then a determination is made as to whether or not a particular data center is assigned to act as the identity provider with respect to the requesting federated entity (step 1126). If the WAYF cookie does not contain an assignment of a particular data center, then the current data center sets the WAYF cookie to indicate that the current data center is assigning itself to act as the identity provider with respect to the requesting federated entity (step 1128). For example, a data center assignment may have been reset as described with respect to the process that is shown FIG. 11A. At some subsequent point in time, e.g., during the processing of a subsequently received resource request, a data center may assign itself as the identity provider at step 1128. The current data center then performs the necessary identity provider operation and generates a response (step 1130) for use in the continuation of the processing of the resource request.

If the WAYF cookie contains an assignment of a data center, then the identity of the assigned data center is extracted from the WAYF cookie (step 1132), and a request for the necessary identity provider operation is sent to the identified data center (step 1134).

If it had been determined at step 1124 that the WAYF cookie indicates that some other federated entity within the federation is acting as the identity provider with respect to the requesting federated entity, then a request for the necessary identity provider operation is sent to the identified identity provider (step 1136).

In any case, the results or responses for the necessary identity provider operation are obtained (step 1138), from whichever source, in order to continue the processing of the current resource request as necessary, as shown in FIG. 9B.

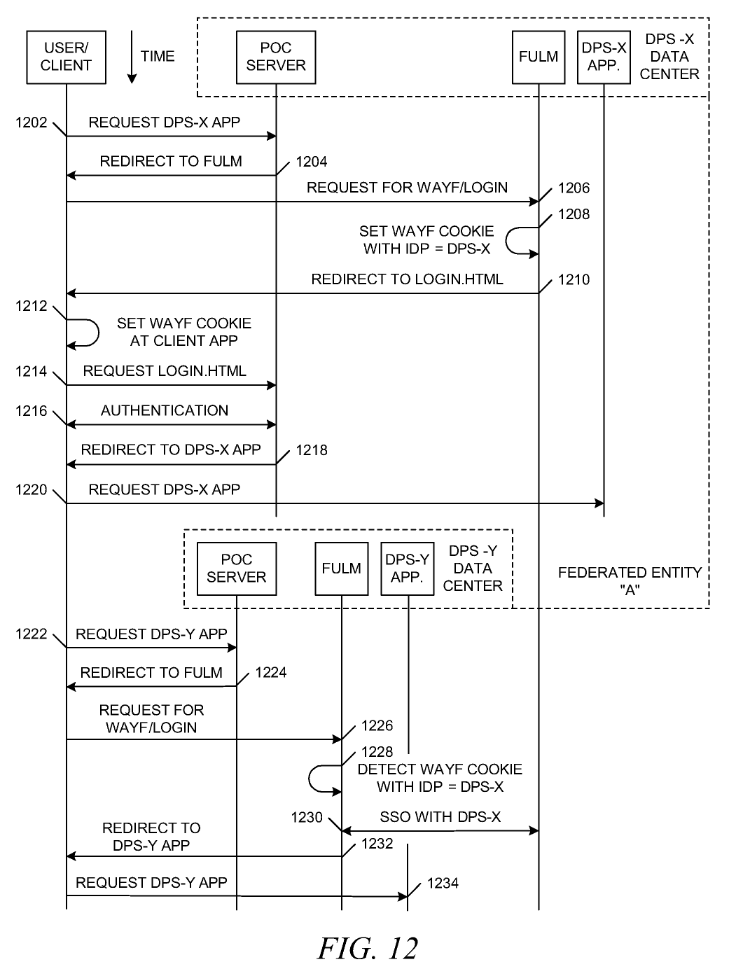

With reference now to FIG. 12, a data flow diagram depicts some of the data traffic that may be transmitted between a federated client or user and a federated entity that supports a floating identity provider in accordance with an embodiment of the present invention. FIG. 12 illustrates a scenario in which a federated client or user is attempting to access protected resources within a federated entity “A” that is implemented as a distributed data processing system comprising multiple data centers or data processing systems that each support a floating identity provider. In the scenario that is shown in FIG. 12, the federated client or user initially attempts to access a protected resource at data center “DPS-X” and then attempts to access a protected resource at data center “DPS-Y”.

It should be noted that the elements that are shown within data center “DPS-X” or data center “DPS-Y” are used only to illustrate the flow of data traffic with respect to the assignment of a floating identity provider; other elements may be used but are not shown. For example, when a point-of-contact server supports an authentication operation, the point-of-contact server may employ the services of an authentication server, as described above with respect to FIG. 3, or a FULM (Federated User Lifecycle Management) component may employ an SPS (Single-Sign-On Protocol Service) component. As yet another example, a web application server may serve as an interface to back-end applications, such as “DPS-X APP” and “DPS-Y APP” that are shown in FIG. 12; the web application server may interact with a federation interface unit/filter and/or the FULM component. The data flow in FIG. 12 commences when the federated client or user sends a request for a protected resource within the federated entity “A” (step 1202). At some point in time, the request is routed to data center “DPS-X”, e.g., via a load balancer, and received at a point-of-contact server within data center “DPS-X”.

Because the client is requesting a protected resource, the point-of-contact server needs to verify the existence of valid security credentials for the client/user. If the client/user has already established a session with data center “DPS-X”, then the client/user may have already been subjected to an authentication operation that generated security credentials; if so, then the point-of-contact server may allow the request for the protected resource to be sent to the appropriate resource. However, if the client/user has not yet been subjected to an authentication operation or if the security credentials of the client/user have expired, then the point-of-contact server determines that an authentication operation is required. The point-of-contact server redirects the client application, e.g., a browser, to a FULM component (step 1204), e.g., in the form of an HTTP redirect message (HTTP Response message with status/reason code “302”).

The redirect message redirects the client to the appropriate location, e.g., as identified by a URI within the “Location” header of the redirect message, that identifies the appropriate service within the federated entity that controls federated authentication operations, e.g., the FULM component. In response to receiving the redirect message from the client, the client sends an HTTP Get message to the appropriate service as indicated by the URI in the HTTP redirect message from the federated entity (step 1206).

When the FULM component receives the request, it determines that the client has been redirected to request a specific login resource. The FULM component determines that the request does not have an associated WAYF cookie, e.g., by determining that the request is not accompanied by a WAYF cookie, or more specifically, by detecting that the HTTP Get request message does not include a header that contains a WAYF cookie. In response, the FULM component creates a WAYF cookie (step 1208) that includes an indication that the WAYF cookie has been created by data center “DPS-X”, thereby assigning itself as the data center that will function as an identity provider with respect to the client for subsequent resource requests when, in the course of processing those requests, the functionality of an identity provider is needed to fulfill those requests and generate responses to those requests. Assuming that the assignment of data center “DPS-X” is temporary with respect to the client, the WAYF cookie is created in a manner that includes an expiration timestamp that limits the time period for which data center “DPS-X” is assigned to the client as its identity provider. The FULM component then redirects the client (step 1210) to a specific login resource, e.g., via an HTTP Redirect message. The request of that login resource will continue the login operation.

The client application receives the redirection message, and upon detecting the WAYF cookie in the message, e.g., within a “Set” header in an HTTP message, the client application then sets or caches the WAYF cookie at the client (step 1212). The client then continues the redirection operation by sending a request to the federated entity for the login resource (step 1214), which in the example that is shown in FIG. 12 is a specific login web page.

In the scenario that is shown in FIG. 12, the point-of-contact server receives the request for the login resource and processes the request, possibly with assistance from an authentication server. An authentication operation is performed between the federated entity and the client/user (step 1216), thereby generating security credentials or otherwise preparing the client's session that will allow the client/user to access protected resources. The point-of-contact server then redirects the client to the originally requested resource (step 1218). In the example scenario, the protected resource is a resource that is provided by a back-end application that is supported at data center “DPS-X”. The client receives the redirection message and sends a request to the back-end application (step 1220). The client/user may then engage in various transactions that employ the protected resource.

At some subsequent point in time, the client attempts to access another protected resource at the federated entity by sending a request for the protected resource (step 1222). In the example scenario, the protected resource is a resource that is provided by a back-end application that is supported at data center “DPS-Y”.

Because the client is requesting a protected resource, the point-of-contact server at data center “DPS-Y” needs to verify the existence of valid security credentials for the client/user. If the client/user has already established a session with data center “DPS-Y”, then the point-of-contact server may allow the request for the protected resource to be sent to the appropriate resource. However, if the point-of-contact server does not have security credentials for the user or they have expired, then the point-of-contact server determines that an authentication operation is required. The point-of-contact server redirects the client application, e.g., a browser, to a FULM component (step 1224), e.g., in the form of an HTTP redirect message. In response to receiving the redirect message from the client, the client sends an HTTP Get message to the appropriate service as indicated by the URI in the HTTP redirect message from the federated entity (step 1226).

When the FULM component receives the request, it determines that the client has been redirected to request a specific login resource. The FULM component determines that the request has an associated WAYF cookie, e.g., by determining that the request is accompanied by a WAYF cookie, or more specifically, by detecting that the HTTP Get request message includes a header that contains a WAYF cookie. In addition, the FULM component at data center “DPS-Y” determines that the WAYF cookie was not set by itself, i.e. data center “DPS-Y”, but rather by data center “DPS-X” (step 1228). Given the valid WAYF cookie, data center “DPS-X” has been assigned to act as the identity provider for the client. Assuming that the WAYF cookie is valid and unexpired, then data center “DPS-X” is able, in its role as an identity provider for the client, to interact with other data centers, such as data center “DPS-Y”, to perform a federated single-sign-on operation or other federated operations for the client as required. Hence, data center “DPS-Y” interacts with data center “DPS-X” to perform a single-sign-on operation (step 1230).

After the FULM component at data center “DPS-Y” has validated security credentials of some type for the client through the SSO operation, the FULM component determines that the client is permitted to access the protected resource that the client had previously requested. The FULM component sends a redirection message to the client (step 1232). In the example scenario, the protected resource is a resource that is provided by a back-end application that is supported at data center “DPS-Y”. The client receives the redirection message and sends a request to the back-end application (step 1234). The client/user may then engage in various transactions that employ the protected resource.

The scenario that is shown in FIG. 12 depicts a federated entity with two data centers. However, the distributed computational environment of the federated entity may comprise many data centers. The present invention provides efficient, distributed provisioning of identity provider functionality across a plurality of data centers.

At some subsequent point in time, the security credentials for the client/user would expire along with the validity of the WAYF cookie. If the client/user later sends another request for a protected resource at data center “DPS-Y”, the data center “DPS-Y” would receive the previously set WAYF cookie along with the incoming request message as included by the client application. However, data center “DPS-Y” would detect that the WAYF cookie had expired and is invalid. Data center “DPS-Y” would determine that the assignment of data center “DPS-X” as the identity provider for the client was also no longer valid. Thus, data center “DPS-Y” would assign itself to act as the identity provider with respect to the client, and data center “DPS-Y” would generate and set a newly valid WAYF cookie to that effect, thereby essentially overwriting the old, invalid WAYF cookie.

Continuing this subsequent scenario, if the client/user subsequently sends a request to access a protected resource at data center “DPS-X”, then data center “DPS-X” would receive the newly valid WAYF cookie along with the request. Data center “DPS-X” would detect that the WAYF cookie indicates that data center “DPS-Y” is acting as the identity provider with respect to the client, and data center “DPS-X” would defer to data center “DPS-Y” for any necessary performance of identity provider operations with respect to the client, such as another single-sign-on operation between data center “DPS-X” and data center “DPS-Y”, albeit with the two data centers having reversed roles with respect to the scenario that is shown in FIG. 12.

### CONCLUSION

The advantages of the present invention should be apparent in view of the detailed description of the invention that is provided above. The present invention supports the implementation of federated entities as distributed data processing systems. The distributed data processing system is composed of multiple data processing systems, each of which is able to provide the functionality of an identity provider, particularly in a manner in which a floating identity provider model can be used to support the floating assignment of identity provider functionality across a distributed processing system.

The present invention is advantageous because it supports a distributed data center environment that is required for large enterprises that may support millions of customers yet in which certain prior art data management techniques are not possible. In addition, the present invention does not require advanced data management techniques that would be required by distributed caches. Moreover, using the present invention, a requesting federated entity, such as a service provider, need not be aware of the distributed nature nor existence of the multiple data centers that provide the functionality for the responding federated entity, such as an identity provider.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, etc. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing transactions in a federated computational environment, the computer-implemented method comprising:
receiving resource requests at a first federated entity from a second federated entity, wherein the first federated entity responds to federation protocol operations for the second federated entity in accordance with a trust relationship between the first federated entity and the second federated entity, wherein services of the first federated entity are provided by a set of data processing systems within a distributed data processing system, and wherein each data processing system in the set of data processing systems is able to act as an identity provider;
establishing a first data processing system in the set of data processing systems, through a self-assignment process by the first data processing system, to act as an identity provider across the set of data processing systems with respect to the second federated entity; and
employing, across the set of data processing systems, the first data center to perform federated protocol operations as an identity provider while processing requests from the second federated entity.

2. The method of claim 1 further comprising:
establishing a second data processing system in the set of data processing systems to act as an identity provider for the set of data processing systems with respect to the second federated entity after an expiration of a configurable time period; and
employing the second data processing system to perform federated protocol operations as an identity provider for requests from the second federated entity.

3. The method of claim 1 further comprising:
setting a cookie to establish the first data processing system as acting as an identity provider for the set of data processing systems with respect to the second federated entity, wherein the cookie includes data that indicates an identity of the first data processing system.

4. The method of claim 3 further comprising:
receiving a resource request at a second data processing system from the second federated entity, wherein the resource request is accompanied by the cookie;
extracting, from the cookie, data indicating the identity of the first data processing system; and
performing a single-sign-on operation for the second federated entity between the second data processing system and the first data processing system.

5. The method of claim 3 further comprising:
generating the cookie to include an expiration value such that the first data processing system is established as the identity provider for a valid time period that is controlled by the expiration value.

6. The method of claim 5 further comprising:
receiving a resource request at a second data processing system from the second federated entity, wherein the resource request is accompanied by the cookie;
extracting the expiration value from the cookie;
modifying the cookie to establish the second data processing system as acting as an identity provider for the set of data processing systems with respect to the second federated entity in response to a determination that a time period for the expiration value has passed, wherein the modified cookie includes data that indicates an identity of the second data center; and
resetting the expiration value.

7. The method of claim 3 further comprising:
modifying the cookie to remove data that indicates the identity of the first data processing system so that the cookie indicates that the first federated entity is acting as an identity provider without an assignment of a particular data processing system to act as an identity provider across the set of data processing systems with respect to the second federated entity.

8. The method of claim 7 further comprising:
receiving a resource request at a second data processing system from the second federated entity, wherein the resource request is accompanied by the cookie;
determining that the cookie does not indicate an assignment of a particular data processing system to act as an identity provider across the set of data processing systems with respect to the second federated entity; and
modifying the cookie to indicate an assignment of the second data processing system to act as an identity provider across the set of data processing systems with respect to the second federated entity.

9. A computer program product on a computer readable storage medium for processing transactions in a federated computational environment, the computer program product comprising:
instructions for receiving resource requests at a first federated entity from a second federated entity, wherein the first federated entity responds to federation protocol operations for the second federated entity in accordance with a trust relationship between the first federated entity and the second federated entity, wherein services of the first federated entity are provided by a set of data processing systems within a distributed data processing system, and wherein each data processing system in the set of data processing systems is able to act as an identity provider;
instructions for establishing a first data processing system in the set of data processing systems, through a self-assignment process by the first data processing system, to act as an identity provider across the set of data processing systems with respect to the second federated entity; and
instructions for employing, across the set of data processing systems, the first data center to perform federated protocol operations as an identity provider while processing requests from the second federated entity.

10. The computer program product of claim 9 further comprising:
instructions for establishing a second data processing system in the set of data processing systems to act as an identity provider for the set of data processing systems with respect to the second federated entity after an expiration of a configurable time period; and
instructions for employing the second data processing system to perform federated protocol operations as an identity provider for requests from the second federated entity.

11. The computer program product of claim 9 further comprising:
instructions for setting a cookie to establish the first data processing system as acting as an identity provider for the set of data processing systems with respect to the second federated entity, wherein the cookie includes data that indicates an identity of the first data processing system.

12. The computer program product of claim 11 further comprising:
instructions for receiving a resource request at a second data processing system from the second federated entity, wherein the resource request is accompanied by the cookie;
instructions for extracting, from the cookie, data indicating the identity of the first data processing system; and
instructions for performing a single-sign-on operation for the second federated entity between the second data processing system and the first data processing system.

13. The computer program product of claim 11 further comprising:
instructions for generating the cookie to include an expiration value such that the first data processing system is established as the identity provider for a valid time period that is controlled by the expiration value.

14. The computer program product of claim 13 further comprising:
instructions for receiving a resource request at a second data processing system from the second federated entity, wherein the resource request is accompanied by the cookie;
instructions for extracting the expiration value from the cookie;
instructions for modifying the cookie to establish the second data processing system as acting as an identity provider for the set of data processing systems with respect to the second federated entity in response to a determination that a time period for the expiration value has passed, wherein the modified cookie includes data that indicates an identity of the second data center; and
instructions for resetting the expiration value.

15. The computer program product of claim 11 further comprising:
instructions for modifying the cookie to remove data that indicates the identity of the first data processing system so that the cookie indicates that the first federated entity is acting as an identity provider without an assignment of a particular data processing system to act as an identity provider across the set of data processing systems with respect to the second federated entity.

16. The computer program product of claim 15 further comprising:
instructions for receiving a resource request at a second data processing system from the second federated entity, wherein the resource request is accompanied by the cookie;
instructions for determining that the cookie does not indicate an assignment of a particular data processing system to act as an identity provider across the set of data processing systems with respect to the second federated entity; and
instructions for modifying the cookie to indicate an assignment of the second data processing system to act as an identity provider across the set of data processing systems with respect to the second federated entity.

17. An apparatus for processing transactions in a federated computational environment, the apparatus comprising:
means for receiving resource requests at a first federated entity from a second federated entity, wherein the first federated entity responds to federation protocol operations for the second federated entity in accordance with a trust relationship between the first federated entity and the second federated entity, wherein services of the first federated entity are provided by a set of data processing systems within a distributed data processing system, and wherein each data processing system in the set of data processing systems is able to act as an identity provider;
means for establishing a first data processing system in the set of data processing systems, through a self-assignment process by the first data processing system, to act as an identity provider across the set of data processing systems with respect to the second federated entity; and
means for employing, across the set of data processing systems, the first data center to perform federated protocol operations as an identity provider while processing requests from the second federated entity.

18. The apparatus of claim 17 further comprising:
means for establishing a second data processing system in the set of data processing systems to act as an identity provider for the set of data processing systems with respect to the second federated entity after an expiration of a configurable time period; and
means for employing the second data processing system to perform federated protocol operations as an identity provider for requests from the second federated entity.

19. The apparatus of claim 17 further comprising:
means for setting a cookie to establish the first data processing system as acting as an identity provider for the set of data processing systems with respect to the second federated entity, wherein the cookie includes data that indicates an identity of the first data processing system.

20. The apparatus of claim 19 further comprising:
means for receiving a resource request at a second data processing system from the second federated entity, wherein the resource request is accompanied by the cookie;
means for extracting, from the cookie, data indicating the identity of the first data processing system; and
means for performing a single-sign-on operation for the second federated entity between the second data processing system and the first data processing system.

21. The apparatus of claim 19 further comprising:
means for generating the cookie to include an expiration value such that the first data processing system is established as the identity provider for a valid time period that is controlled by the expiration value.

22. The apparatus of claim 21 further comprising:
means for receiving a resource request at a second data processing system from the second federated entity, wherein the resource request is accompanied by the cookie;
means for extracting the expiration value from the cookie;
means for modifying the cookie to establish the second data processing system as acting as an identity provider for the set of data processing systems with respect to the second federated entity in response to a determination that a time period for the expiration value has passed, wherein the modified cookie includes data that indicates an identity of the second data center; and
means for resetting the expiration value.

23. The apparatus of claim 19 further comprising:
means for modifying the cookie to remove data that indicates the identity of the first data processing system so that the cookie indicates that the first federated entity is acting as an identity provider without an assignment of a particular data processing system to act as an identity provider across the set of data processing systems with respect to the second federated entity.

24. The apparatus of claim 23 further comprising:
means for receiving a resource request at a second data processing system from the second federated entity, wherein the resource request is accompanied by the cookie;
means for determining that the cookie does not indicate an assignment of a particular data processing system to act as an identity provider across the set of data processing systems with respect to the second federated entity; and
means for modifying the cookie to indicate an assignment of the second data processing system to act as an identity provider across the set of data processing systems with respect to the second federated entity.
